(19) United States
(12) Patent Application Publication
(10) Pub. No.: US 2024/0381397 A1
(43) Pub. Date: Nov. 14, 2024

(54) METHOD FOR ALLOCATING RESOURCE IN SIDELINK SYSTEM AND USER EQUIPMENT PERFORMING THE METHOD

(71) Applicant: SAMSUNG ELECTRONICS CO., LTD., Suwon-si (KR)

(72) Inventors: Min WU, Beijing (CN); Miao ZHOU, Beijing (CN); Feifei SUN, Beijing (CN)

(21) Appl. No.: 18/660,091

(22) Filed: May 9, 2024

(30) Foreign Application Priority Data
May 12, 2023 (CN) 202310540112.5
Aug. 9, 2023 (CN) 202311001394.8

(51) Int. Cl. H04W 72/40; H04B 17/318; H04W 16/28; H04W 72/25

(52) U.S. Cl. CPC H04W 72/40; H04B 17/328; H04W 16/28; H04W 72/25

(57) ABSTRACT

The disclosure relates to a 5G or 6G communication system for supporting a higher data transmission rate. A method performed by a user equipment (UE) in a wires communication system is provide. The method comprises identifying a resource subset corresponding to a transmission beam and identifying one or more resources from the resource subset for a transmission for at least one of a physical sidelink shared channel (PSSCH) or physical sidelink control channel (PSCCH) in a direction of the transmission beam.

### CROSS-REFERENCE TO RELATED APPLICATIONS

This application is based on and claims priority under 35 U.S.C. § 119 to Chinese Patent Application No. 202310540112.5 filed on May 12, 2023, and Chinese Patent Application No. 202311001394.8 filed on Aug. 9, 2023, in the Chinese Intellectual Property Office, the disclosure of which is/are incorporated by reference herein in their entireties.

### BACKGROUND

### 1. Field

The present disclosure relates to the field of wireless communication, and specifically to a method for allocating a resource in a sidelink system and a user equipment (UE) performing the method in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

A method performed by a user equipment (UE) in a wires communication system is provided. The method comprises identifying a resource subset corresponding to a transmission beam and identifying one or more resources from the resource subset for a transmission for at least one of a physical sidelink shared channel (PSSCH) or physical sidelink control channel (PSCCH) in a direction of the transmission beam.

A user equipment (UE) in a wires communication system is provided. The UE comprises a transceiver and a controller coupled with the transceiver and configured to identify a resource subset corresponding to a transmission beam, and identify one or more resources from the resource subset for a transmission for at least one of a physical sidelink shared channel (PSSCH) or physical sidelink control channel (PSCCH) in a direction of the transmission beam.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates example wireless transmission and reception paths according to various embodiments of the present disclosure;

FIG. 2B illustrates example wireless transmission and reception paths according to various embodiments of the present disclosure;

FIG. 3A illustrates an example UE and an example gNB according to various embodiments of the present disclosure;

FIG. 3B illustrates an example UE and an example gNB according to various embodiments of the present disclosure;

FIG. 4 is a schematic flow diagram of a method for allocating a resource according to various embodiments of the present disclosure;

FIG. 5 is a schematic flowchart of a method for allocating a resource according to various embodiments of the present disclosure;

FIG. 6 illustrates an exemplary corresponding relationship between a transmission beam and a slot according to various embodiments of the present disclosure;

FIG. 7 illustrates an exemplary corresponding relationship between a reception beam and a slot according to various embodiments of the present disclosure;

FIG. 8 illustrates an exemplary beam direction according to various embodiments of the present disclosure;

FIG. 8A is an example diagram of an SL MAC CE reporting a sidelink transmission beam to a base station according to various embodiments of the present disclosure;

FIG. 8B is an example diagram of an SL MAC CE reporting a sidelink transmission beam to a base station according to various embodiments of the present disclosure; and

FIG. 9 illustrates an exemplary structure of a user equipment UE according to various embodiments of the present disclosure.

### DETAILED DESCRIPTION

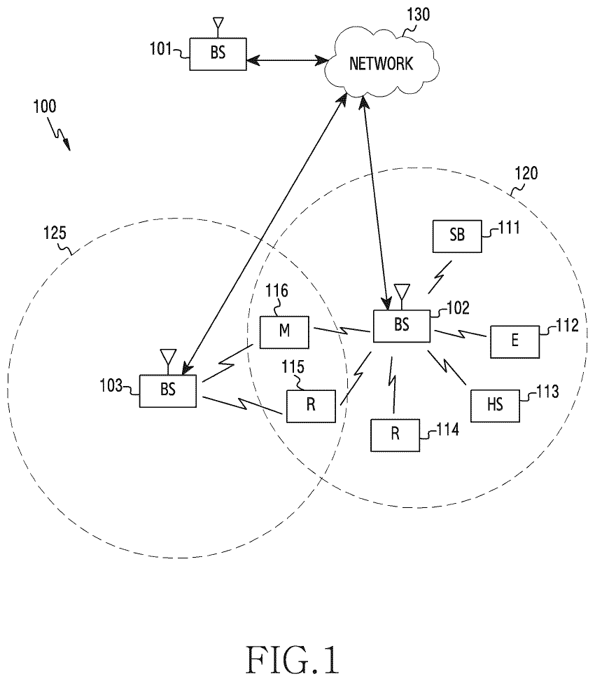

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems.”

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

According to an aspect of the present disclosure, a method performed by a user equipment (UE) is provided. The method comprises: determining a resource subset corresponding to a transmission beam; and selecting one or more resources from the resource subset for a physical sidelink shared channel (PSSCH)/physical sidelink control channel (PSCCH) transmission in a direction of the transmission beam.

In an exemplary embodiment, determining the resource subset corresponding to the transmission beam comprises at least one of: selecting some time units from a resource selection window as candidate time units for the transmission beam, resources in the candidate time units being candidate resources, and determining the resource subset after a resource exclusion from an initial set of candidate resources; selecting some time units from a resource sensing window as sensing time units for the transmission beam, and determining the resource subset after a resource exclusion from the initial set of candidate resources according to the sensing time units; determining time units sensed using a second reception beam as unsensed time units, and determining the resource subset after a resource exclusion from the initial set of candidate resources according to the unsensed time unit, where a direction of the second reception beam is different from a direction of the transmission beam; or determining a reference signal received power (RSRP) threshold value according to a reception beam of sidelink control information (SCI) received at a sensing time unit, and determining the resource subset after a resource exclusion from the initial set of candidate resources according to the determined RSRP threshold value.

In an exemplary embodiment, the direction of the second reception beam is opposite to the direction of the transmission beam.

In an exemplary embodiment, determining the resource subset corresponding to the transmission beam may comprise at least one of: determining, at a time, a resource subset corresponding to a transmission beam, the transmission beam being provided by a higher layer; determining, at a time, a resource subset corresponding to each transmission beam in a set of transmission beams respectively, the set of transmission beams being provided by the higher layer; or determining, at a time, a resource subset corresponding to each supported transmission beam respectively.

In an exemplary embodiment, determining the resource subset corresponding to the transmission beam may comprise at least one of: selecting, for the transmission beam, some time units from a resource selection window as candidate time units, resources on the candidate time units are candidate resources, and determining the resource subset after a resource set exclusion based on an initial candidate resource; selecting some time units from a resource sensing window as sensing time units for the transmission beam, and determining the resource subset after a resource exclusion from an initial set of candidate resources according to the sensing time units; determining time units sensed using a second reception beam as unsensed time units, and determining the resource subset after a resource exclusion from the initial set of candidate resources according to the unsensed time unit, where, specifically, if a periodic resource corresponding to the time unit overlaps with a periodic resource corresponding to a candidate resource, the candidate resource is excluded from the initial set of candidate resources, and a direction of the second reception beam is different from a direction of the transmission beam or the direction of the second reception beam is opposite to the direction of the transmission beam; or determining a reference signal received power (RSRP) threshold value according to a reception beam of sidelink control information (SCI) received at a sensing time unit, and determining the resource subset after a resource exclusion from the initial set of candidate resources according to the determined RSRP threshold value, where, specifically, if the sidelink control information SCI (the SCI indicating a reserved resource, and a periodic resource corresponding to a reserved resource indicated by the SCI overlapping with the periodic resource corresponding to a candidate resource) is received at the sensing time unit, the reference signal received power (RSRP) threshold value is determined according to a reception beam receiving the SCI, and the candidate resource is excluded from the initial set of candidate resources if a RSRP value measured based on the SCI is greater than the RSRP threshold value.

In an exemplary embodiment, selecting some time units from a resource selection window as candidate time units for the transmission beam at least one of: mapping each transmission beam in a set of transmission beams to one time unit or a set of consecutive time units sequentially and periodically, and selecting time units corresponding to the transmission beam from the resource selection window as candidate time units; selecting, according to information on the time units corresponding to the transmission beam that is provided by a higher layer, the time units corresponding to the transmission beam from the resource selection window as candidate time units; or selecting, according to time units sensed using a first reception beam in the resource sensing window, time units corresponding to the transmission beam from the resource selection window as candidate time units, a direction of the first reception beam being identical to the direction of the transmission beam.

In an exemplary embodiment, when each transmission beam in the set of transmission beams is mapped to one time unit or a set of consecutive time units, the time unit mapped to the transmission beam may comprise a sidelink time unit and a non-sidelink time unit; or the time unit mapped to the transmission beam may be a sidelink time unit.

In an exemplary embodiment, when each transmission beam in the set of transmission beams is mapped to one time unit or a of consecutive time units sequentially and periodically, the set of transmission beams may comprise at least one of: all supported transmission beams; a set of transmission beams provided by the higher layer; a set of transmission beams, wherein each transmission beam is separately configured for PSSCH/PSCCH of one PC5-RRC connection; or a union set of some sets of candidate transmission beams, wherein each set of candidate transmission beams is separately configured for the PSSCH/PSCCH of one PC5-RRC connection.

In an exemplary embodiment, the method for allocating a resource according to the present disclosure may further comprise: mapping different transmission beams to time units starting from a predefined time unit. For example, the predefined time unit may be, for example, a sidelink time unit numbered 0, or the predefined time unit may be the first sidelink time unit in the resource selection window.

In an exemplary embodiment, when each transmission beam in the set of transmission beams is mapped to one time unit or a set of consecutive time units sequentially and periodically, the method further comprises: determining, according to an index of a time unit, an index of a transmission beam corresponding to the time unit.

In an exemplary embodiment, the number of the candidate time units selected from the resource selection window for the transmission beam may be greater than or equal to a preset number; or the ratio of the number of the candidate time units selected from the resource selection window for the transmission beam to the number of all sidelink time units in the resource selection window may be greater than or equal to a preset ratio.

In an exemplary embodiment, if the number of the candidate time units selected for the transmission beam is less than a preset number, an additional time unit may be selected from the resource selection window until the number of the candidate time units is greater than or equal to the preset number; or if the ratio of the number of the candidate time units selected for the transmission beam to the number of all sidelink time units in the resource selection window is less than a preset ratio, an additional time unit may be selected from the resource selection window until the ratio is greater than or equal to the preset ratio.

In an exemplary embodiment, selecting, according to the time unit sensed by the UE using the first reception beam in the resource sensing window, the time unit corresponding to the transmission beam from the resource selection window as the candidate time unit may comprise: selecting, if a time unit (n) is sensed using the first reception beam, time units (n+P*k) periodically corresponding to the time unit (n) at a preset interval as the candidate time units, where P is the preset interval and k is a number of the preset intervals.

In an exemplary embodiment, selecting some time units from a resource sensing window as sensing time units for the transmission beam may comprise at least one of: mapping each reception beam in a set of reception beams to one time unit or a set of consecutive time units sequentially and periodically, and selecting time units corresponding to a first reception beam from the resource sensing window as sensing time units; selecting, according to information on the time units corresponding to the first reception beam that is provided by a higher layer, the time units corresponding to the first reception beam from the resource sensing window as sensing time units; selecting, according to candidate time units selected from the resource selection window for the transmission beam, the time units corresponding to the first reception beam from the resource sensing window as sensing time units; or selecting time units sensed using the first reception beam in the resource sensing window as sensing time units. Here, the direction of the first reception beam is identical to the direction of the transmission beam.

In an exemplary embodiment, the method for allocating a resource according to the present disclosure may further comprise: performing sensing using the first reception beam on the selected sensing time unit.

In an exemplary embodiment, when each reception beam in the set of reception beams is mapped to one time unit or a set of consecutive time units sequentially and periodically, the time unit mapped to the reception beam may comprise a sidelink time unit and a non-sidelink time unit; or the time unit mapped to the reception beam may be a sidelink time unit.

In an exemplary embodiment, when each reception beam in the set of reception beams is mapped to one time unit or a set of consecutive time units sequentially and periodically, the method further comprises: determining, according to an index of a time unit, an index of a reception beam corresponding to the time unit.

In an exemplary embodiment, when each reception beam in the set of reception beams is mapped to one time unit or a set of consecutive time units sequentially and periodically, the set of reception beams may comprise at least one of: all supported reception beams; a set of reception beams provided by the higher layer; a set of reception beams, wherein each reception beam is separately paired with a transmission beam of PSSCH/PSCCH of one PC5-RRC connection; or a union set of some sets of candidate reception beams, wherein each set of candidate reception beams is separately paired with the set of candidate transmission beams of the PSSCH/PSCCH of one PC5-RRC connection.

In an exemplary embodiment, the method for allocating a resource according to the present disclosure may further comprise: mapping different reception beams to time units starting from a predefined time unit. For example, the predefined time unit may be, for example, a sidelink time unit numbered 0, or the predefined time unit may be the first sidelink time unit in the resource sensing window.

In an exemplary embodiment, the number of the sensing time units selected from the resource sensing window for the reception beam may be greater than or equal to a preset number; or the ratio of the number of the sensing time units selected from the resource sensing window for the reception beam to the number of all sidelink time units in the resource sensing window is greater than or equal to a preset ratio.

In an exemplary embodiment, in case that the number of the sensing time units selected from the resource sensing window for the reception beam is less than a preset number, an additional time unit may be selected from the resource sensing window until the number of the sensing time units is greater than or equal to the preset number; or in case that the ratio of the number of the sensing time units selected from the resource sensing window for the reception beam to the number of all sidelink time units in the resource sensing window is less than a preset ratio, an additional time unit may be selected from the resource sensing window until the ratio is greater than or equal to the preset ratio.

In an exemplary embodiment, selecting, according to candidate time units selected from the resource selection window for the transmission beam, the time units corresponding to the first reception beam from the resource sensing window as sensing time units may comprise: selecting, if a time unit (n) is the candidate time unit selected for the transmission beam, time units (n-P*k) periodically corresponding to the time unit (n) with a preset interval before the time unit (n) as the sensing time units, where P is the preset interval and k is a number of the preset intervals.

In an exemplary embodiment, determining the RSRP threshold value according to the reception beam receiving the SCI may comprise: determining, if the SCI is received using a first reception beam, a first RSRP threshold value as the corresponding RSRP threshold value; and determining, if the SCI is received using a second reception beam, a second RSRP threshold value as the corresponding RSRP threshold value. Here, the direction of the first reception beam is identical to the direction of the transmission beam, and the direction of the second reception beam is direction from the direction of the transmission beam. Here, the first RSRP threshold value is direction from the second RSRP threshold value. In an exemplary embodiment, the second RSRP threshold value is determined based on the first RSRP threshold value. For example, the second RSRP threshold value is obtained by increasing or decreasing the first RSRP threshold value by a preset amount. For example, the preset amount is Di,j, where i is the index value of a transmission beam and j is the index value of a reception beam. The preset amounts Di,j are configured for different transmission beams i and reception beams j respectively.

In an exemplary embodiment, determining the RSRP threshold value according to the reception beam receiving the SCI may comprise: determining, if the SCI is received using a first reception beam, a first RSRP threshold value as the corresponding RSRP threshold value; determining, if the SCI is received using a second reception beam and the transmission beam for the PSSCH/PSCCH on the reserved resource indicated by the SCI is the same as the transmission beam for the SCI, a third RSRP threshold value as the corresponding RSRP threshold value; and determining, if the SCI is received using the second reception beam and the transmission beam for the PSSCH/PSCCH on the reserved resource indicated by the SCI is different from the transmission beam for the SCI, a fourth RSRP threshold value as the corresponding RSRP threshold value. Here, the direction of the first reception beam is identical to the direction of the transmission beam, the direction of the second reception beam is direction from the direction of the transmission beam, and the third RSRP threshold value and the fourth RSRP threshold value are different.

In an exemplary embodiment, the time unit comprises any one of a slot, a sub-slot or a symbol.

According to another aspect of the present disclosure, a user equipment (UE) is provided. The UE comprises: a transceiver and a processor. Here, the transceiver is configured to transmit and receive a signal, and the processor is coupled to the transceiver and configured to perform the method for allocating a resource according to any of the above embodiments.

According to another aspect of the present disclosure, a computer readable storage medium storing a computer instruction is provided. The computer instruction, when executed by a processor of a user equipment (UE), causes the processor to perform the method for allocating a resource according to any of the above embodiments.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

Referring to FIG. 1, the wireless network 100 includes a gNodeB (gNB) 101, a gNB 102, and a gNB 103. The gNB 101 communicates with the gNB 102 and the gNB 103. The gNB 101 also communicates with at least one internet protocol (IP) network 130, such as the Internet, a private IP network, or other data networks.

Depending on a type of the network, other well-known terms such as “base station” or “access point” can be used instead of “gNodeB” or “gNB.” For convenience, the terms “gNodeB” and “gNB” are used in this patent document to refer to network infrastructure components that provide wireless access for remote terminals. And, depending on the type of the network, other well-known terms such as “mobile station,” “user station,” “remote terminal,” “wireless terminal” or “user apparatus” can be used instead of “user equipment” or “UE.” For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

A gNB 102 provides wireless broadband access to the network 130 for a first plurality of UEs within a coverage area 120 of the gNB 102. The first plurality of UEs include a UE 111, which may be located in a small business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless personal digital assistant (PDA), etc. The gNB 103 provides wireless broadband access to network 130 for a second plurality of UEs within a coverage area 125 of the gNB 103. The second plurality of UEs include a UE 115 and a UE 116. In some embodiments, one or more of gNBs 101-103 can communicate with each other and with UEs 111-116 using 5G, long term evolution (LTE), LTE-advanced (A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a two-dimensional (2D) antenna array as described in embodiments of the present disclosure. In some embodiments, one or more of the gNB 101, the gNB 102, and the gNB 103 support codebook designs and structures for systems with 2D antenna arrays.

Although FIG. 1 illustrates an example of the wireless network 100, various changes can be made to FIG. 1. The wireless network 100 may include any number of gNBs and any number of UEs in any suitable arrangement, for example. Furthermore, the gNB 101 may directly communicate with any number of UEs and provide wireless broadband access to the network 130 for those UEs. Similarly, each gNB 102-103 may directly communicate with the network 130 and provide direct wireless broadband access to the network 130 for the UEs. In addition, the gNB 101, 102 and/or 103 can provide access to other or additional external networks, such as external telephone networks or other types of data networks.

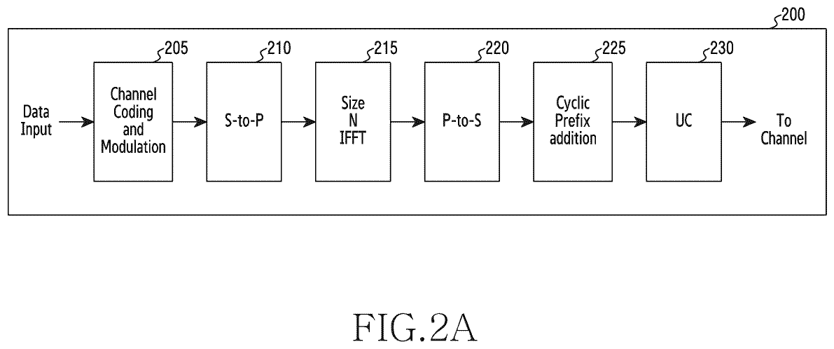

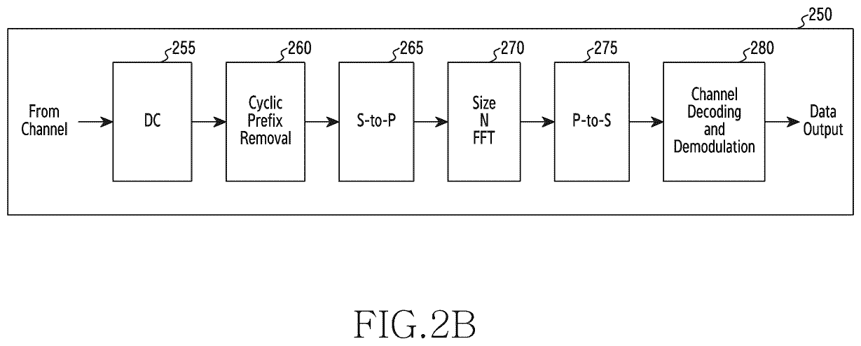

FIGS. 2A and 2B illustrate examples wireless transmission and reception paths according to various embodiments of the present disclosure. In the following description, the transmission path 200 may be described as being implemented in a gNB, such as the gNB 102, and the reception path 250 may be described as being implemented in a UE, such as the UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time-domain output signal. The parallel-to-serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B may be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B may be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

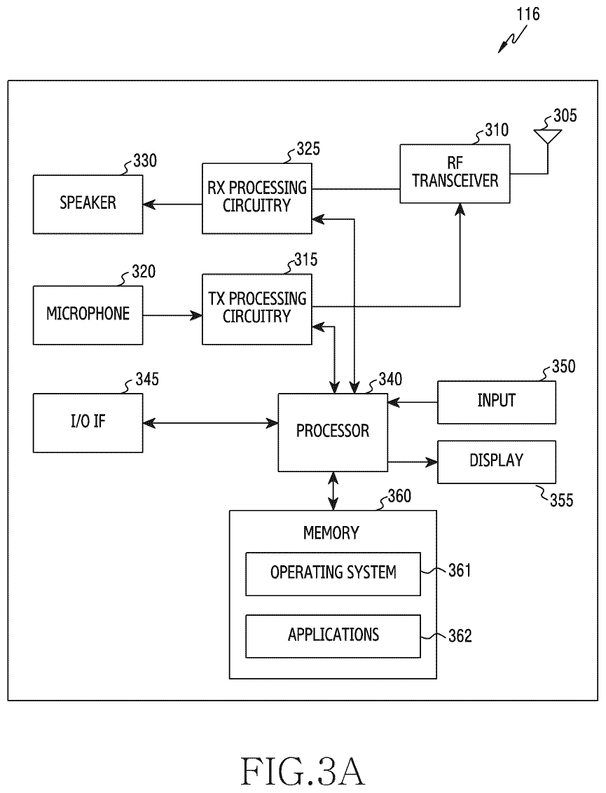

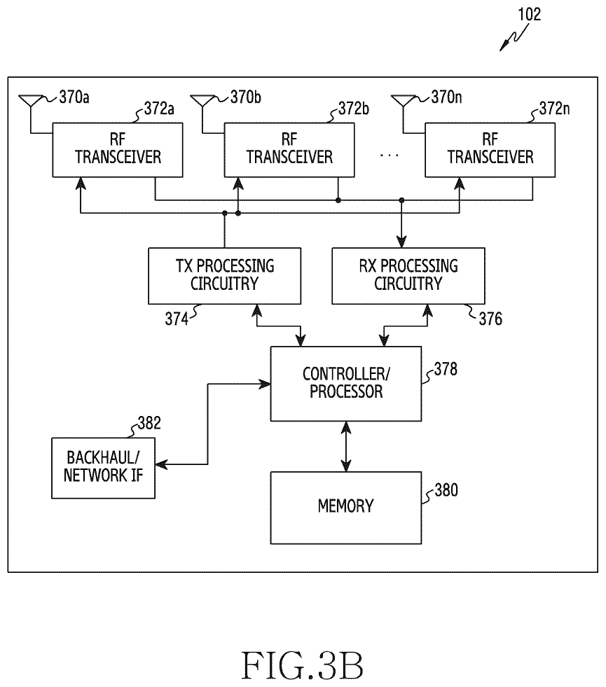

FIG. 3A illustrates an example UE 116 according to various embodiments of the present disclosure. The embodiment of the UE 116 shown in FIG. 3A is for illustration only, and UEs 111-115 of FIG. 1 may have the same or similar configuration. However, a UE has various configurations, and FIG. 3A does not limit the scope of the present disclosure to any specific implementation of the UE.

The UE 116 includes an antenna 305, a RF transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband (BB) signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of the UE 116. For example, the processor/controller 340 may control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 may move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides the UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of the UE 116 may input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes can be made to FIG. 3A. For example, various components in FIG. 3A may be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3B illustrates an example gNB 102 according to various embodiments of the present disclosure. The embodiment of the gNB 102 shown in FIG. 3b is for illustration only, and other gNBs of FIG. 1 can have the same or similar configuration. However, a gNB has various configurations, and FIG. 3B does not limit the scope of the present disclosure to any specific implementation of a gNB. It should be noted that the gNB 101 and the gNB 103 can include the same or similar structures as the gNB 102.

As shown in FIG. 3B, the gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 may include one or more processors or other processing devices that control the overall operation of the gNB 102. For example, the controller/processor 378 may control the reception of forward channel signals and the transmission of backward channel signals through the RF transceivers 372a-372n, the RX processing circuit 376 and the TX processing circuit 374 according to well-known principles. The controller/processor 378 may also support additional functions, such as higher-level wireless communication functions. For example, the controller/processor 378 may perform a blind interference sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 may execute programs and other processes residing in the memory 380, such as a basic OS. The controller/processor 378 may also support channel quality measurement and reporting for systems with 2D antenna arrays as described in embodiments of the present disclosure. In some embodiments, the controller/processor 378 supports communication between entities such as web real-time communications (RTCs). The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or new radio (NR), LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 may include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of the gNB 102 (implemented using RF transceivers 372a-372n, TX processing circuit 374 and/or RX processing circuit 376) support aggregated communication with frequency division duplex (FDD) cells and time division duplex (TDD) cells.

Although FIG. 3B illustrates an example of the gNB 102, various changes may be made to FIG. 3B. For example, the gNB 102 may include any number of each component shown in FIG. 3A. As a specific example, the access point may include many backhaul or network interfaces 382, and the controller/processor 378 may support routing functions to route data between different network addresses. As another specific example, although shown as including a single instance of the TX processing circuit 374 and a single instance of the RX processing circuit 376, the gNB 102 may include multiple instances of each (such as one for each RF transceiver).

In the above system, the communication interface between a network base station and the UE is referred to as a UU interface. The UE performs the data transmission with the network base station through the UU interface. Two UEs having a communication requirement can access the same network through their respective UU interfaces and implement a communication based on the data transfer within the network. However, in a sidelink communication system, two UEs that are close to each other can communicate directly without transferring data through the network base station. The radio link between the two UEs is referred to as a sidelink (SL), and the communication interface between the two UEs is referred to as a PC5 interface.

In the sidelink communication system, there are three communication modes supported, which are broadcast, multicast and unicast respectively. The broadcast refers to that a UE transmits data to all surrounding UEs, the multicast refers to that a UE transmits data to a specific set of surrounding UEs, and the unicast refers to a UE transmits data to one specific surrounding UE. For the unicast, there may be a PC5 radio resource control (RRC) connection established between the two UEs to control the underlying physical transmission. The current sidelink system has the following main types of physical channels/signals: a physical sidelink broadcast channel (PSBCH), a physical sidelink control channel (PSCCH), a physical sidelink shared channel (PSSCH), a physical sidelink feedback channel (PSFCH), and a sidelink channel state information reference signal (CSI-RS). Here, the PSBCH is used to synchronize and indicate important broadcast information. The PSCCH is used to indicate the resource allocation for the PSSCH (including the reserved resource for a next PSSCH transmission), a transmission parameter (e.g., relevant information such as a modulation coding scheme (MCS) and a demodulation reference signal (DMRS)), and other information (e.g., a priority and a PSFCH resource overhead). The PSSCH is used to carry data. The PSFCH is used to feed back the decoding result of the PSSCH (including acknowledgement (ACK) for successful decoding and negative acknowledgement (NACK) for unsuccessful decoding). The CSI-RS is used for a channel estimation. The current system supports only an aperiodic CSI-RS. The aperiodic CSI-RS is always transmitted together with the PSSCH, that is, the aperiodic CSI-RS does not have the characteristic of independent transmission.

In a wireless communication system, for example, in a fifth-generation (5G) NR system, the current sidelink communication is only for a low frequency band (e.g., an FR1 frequency band of which the carrier frequency range is 450 MHz-6000 MHz). Due to the serious shortage of spectral resources in the low frequency band, it is necessary to support the sidelink communication in a high frequency band (e.g., an FR2 frequency band of which the carrier frequency range is 24250 MHz-52600 MHz) in the Rel-18 version of the sidelink communication system. Since the fading of a high frequency carrier wave in a wireless transmission environment is extremely serious, it is required to use narrow beams for transmission to improve the coverage. Hereinafter, the low frequency band is described by taking FR1 as an example, and the high frequency band is described by taking FR2 as an example. However, it can be understood that the low frequency band is not limited to FR1 frequency band and may be other low frequency bands, and the high frequency band is not limited to FR2 frequency band and may be other high frequency bands.

The main difference between the FR2 communication and the FR1 communication is that a directional beam is used in the FR2 communication for transmission (i.e., all channels/signals are transmitted in a specific beam direction), so that the transmission power can be gathered in a certain direction to increase the signal power at a receiver, thereby improving the range of coverage. In the FR2 scenario of the sidelink communication, the method for allocating a resource for the FR1 scenario needs to be modified.

In the resource allocation procedure for the FR1 scenario, the UE autonomously selects a sidelink resource for a PSCCH/PSSCH transmission in a preconfigured sidelink resource pool. The basic condition for the autonomous selection for the sidelink resource is to perform a sensing on the sidelink resource pool in advance. The sensing includes attempting to decode all PSCCHs, and when a PSCCH is successfully decoded, measuring the reference signal received power (RSRP) of a layer 1 (L1) based on the DMRS of the corresponding PSCCH/PSSCH to autonomously select the sidelink resource, thereby reducing the interference level in the sidelink resource pool to the greatest extent. The UE performs the sensing on the sidelink resource mainly by monitoring the PSCCH transmitted by another UE. The PSCCH transmitted by the other UE may indicate that one or more sidelink resources are reserved by the other UE for a subsequent PSCCH/PSSCH transmission. According to the decoding for the PSCCH, the UE performing the sensing may learn the sidelink resource reserved by the other UE. The UE performing the sensing further measures the DMRS of the PSCCH/PSSCH to determine the L1-RSRP of the other UE. In case that the L1-RSRP value of the other UE is low (e.g., less than a certain threshold value), it indicates that the other UE is far from the UE performing the sensing, and the sidelink resource reserved by the other UE can be used by the UE performing the sensing, and thus does not need to be excluded from a target resource set. In case that the L1-RSRP value of the other UE is high (e.g., greater than a certain threshold value), it indicates that the other UE is close to the UE performing the sensing, and the sidelink resource reserved by the other UE cannot be used by the UE performing the sensing, and thus needs to be excluded from the target resource set.

The Mode2 autonomous resource allocation procedure is performed by the physical layer of the UE. The purpose is to determine a resource subset S_{A}. The Mode2 resource allocation procedure performed by the UE in a slot n may be briefly described as the following steps:

In step 1, a resource selection window [n+T₁, n+T₂] is determined. In case that the UE performs a full sensing, each slot belonging to a sidelink resource pool in the resource selection window is used as a candidate slot. In case that the UE performs a partial sensing, some slots belonging to the sidelink resource pool in the resource selection window are used as candidate slots. Sub-channels in the corresponding sidelink resource pool in the candidate slots are used as candidate resources. That is, a candidate single-slot resource R_{x,y} is determined based on [n+T₁, n+T₂]. The R_{x,y} is defined as a set of L_{subCH} contiguous sub-channels with sub-channel x+j in slot t′_{y}^{SL}, wherein j=0, . . . , L_{subCH}−1. The total number of candidate single-slot resources is denoted by Mₜₒₜₐₗ. T1 and T2 are values counted according to slots. The UE selects a value from the range 0≤T₁≤T_{proc,1}^{SL} as the value of T₁ up to UE implementation, where T_{proc,1}^{SL} is a predefined value. In case that the remaining packet delay budget is greater than a predefined value T₂ₘᵢₙ he UE selects a value from the range T₂ₘᵢₙ≤T₂≤e remaining packet delay budget (PDB) as the value of T2; otherwise, the value of T₂ is set to the remaining packet delay budget.

In step 2, a resource sensing window [n−T₀, n−T_{proc,0}^{SL}) is determined. For the full sensing, the UE may perform sensing in each slot belonging to a sidelink resource pool in the resource sensing window, except for the slot(s) in which the UE is to transmit its own sidelink channel. For the partial sensing, the UE performs sensing in some slots belonging to the sidelink resource pool in the resource sensing window. Performing sensing in the slots refers to that the UE performs a PSCCH decoding and an RSRP measurement in these slots. According to the sensing result, the UE excludes the candidate resource which does not meet a preset condition from the candidate resources, thereby a candidate resource subset is determined. Here, T₀ and T_{proc,1}^{SL} are both predefined values.

In step 3, an initial RSRP threshold value Th(pᵢ, pⱼ) is set, which is indicated by the i-th filed in a preconfigured parameter sl-Thres-RSRP-List, where i=pᵢ+(pⱼ−1)*8.

In step 4, a set S_{A} is initialized to the set of all the candidate single-slot resources R_{x,y}.

In step 5, the UE excludes any candidate single-slot resource R_{x,y} meeting the following conditions from the set S_{A}:
the UE has not performed sensing in the slot t′ₘ^{SL} in step 2; and
for any periodicity value allowed by the higher layer parameter sl-ResourceReservePeriodList and a hypothetical SCI format received in slot t′ₘ^{SL}, with “Resource reservation period” field set to that periodicity value and indicating all subchannels of the resource pool in this slot, condition c in step 6 may be met. In other words, in case that the UE may perform sensing in a slot but does not perform the sensing, and in case that a slot reserved corresponding to the periodicity value overlaps with a slot reserved corresponding to the candidate resource, the candidate single-slot resource R_{x,y} may be excluded.

In step 5a, in case that the number of the remaining candidate single-slot resources in the set S_{A} is less than a preset threshold value (X·Mₜₒₜₐₗ), S_{A} is initialized to the set of all the candidate single-slot resources as in step 4.

In step 6, the UE excludes any candidate single-slot resource R_{x,y} meeting the following conditions from the set S_{A}:
Condition a: the UE receives an SCI in the slot t′ₘ^{SL}, and the “Resource reservation period” field and the “Priority” field in the SCI indicate the values of P_{rsvp_RX} and prio_{RX} respectively;
Condition b: the RSRP value measured based on the received SCI is greater than a threshold value Th(prio_{RX}, prio_{TX}). Here, prio_{TX} is the priority value of a PSSCH/PSCCH transmission indicated by a higher layer of the UE, and prio_{RX} is the priority value indicated in the SCI; and
Condition c: the SCI received in the slot t′ₘ^{SL} includes the “Resource reservation period” field (i.e., the resource indicated by the SCI is reserved periodically), and a resource reserved corresponding to the SCI overlaps with a resource reserved correspondpg to the candidate resource (i.e., the reserved resource of the SCI in a slot

$${t}_{m + q \times {P}_{rsvp \_ RX}^{′}}^{′ SL}$$

overlaps with the reserved resource

$${R}_{x , y + j \times {P}_{{rsvp}_{TX}}^{′}}$$

corresponding to the candidate resource, where q=1, 2, . . . , Q, and j=0, 1, . . . , Cᵣₑₛₑₗ−1). In other words, the resource reserved periodically by another UE collides with the candidate resource or the reserved resource corresponding to the candidate resource. Here, P_{rsvp_RX}′ is the number of logical slots converted based on P_{rsvp_RX}, and P_{rsvp_TX}′ is the number of logical slots converted based on P_{rsvp_TX}. Here, P_{rsvp_RX} is a resource periodicity indicated by the higher layer for this resource allocation, and the conversion formula is

$${P}_{rsvp}^{′} = ⌈ \frac{{T}_{max}^{′}}{10240 ms} \times {P}_{rsvp} ⌉ ,$$

T′ₘₐₓing a total number of slots except for the reserved slots, a non-sidelink resource pool slots and SL-SSB slots within 10240 ms.

Considering the conditions a-c in combination, the exclusion conditions may be simply summarized as: if the periodically reserved resource indicated by the other UE through the SCI collides with the candidate single-slot resource, or the periodically reserved resource indicated by the other UE through the SCI collides with the periodically reserved resource corresponding to the candidate single-slot resource, and the RSRP measured based on this SCI is greater than a preset threshold value, the candidate single-slot resource R_{x,y} may be excluded.

In step 7, in case that the number of the remaining candidate single-slot resources in the set S_{A} is less than a preset threshold value (X·Mₜₒₜₐₗ), the RSRP threshold value Th(pᵢ, pⱼ) is increased by 3 dB for each priority value, and the procedure continues with step 4.

Exemplary embodiments of the present disclosure are further described below in combination with the accompanying drawings.

In the present disclosure, for ease of description, a UE transmitting data is referred to as a transmission UE (i.e., TX UE), first UE or UE1, and a UE receiving data is referred to as a reception UE (i.e., RX UE), second UE or UE2. A PC5-RRC connection may be established between the TX UE and the RX UE to support unicast transmission. The ID of TX UE is referred to as a source ID, and the ID of the RX UE is referred to as a destination ID. The TX UE transmits a PSCCH/PSSCH to the RX UE, and the RX UE feeds back a PSFCH to the TX UE. In addition, the RX UE also transmits a reverse PSCCH/PSSCH to the TX UE, and the TX UE also transmits a PSFCH to the RX UE. That is, the same UE may be the TX UE or RX UE in different transmissions.

In the present disclosure, a beam refers to an analog beam in an FR2 scenario, and may correspond to a spatial filter. A transmission beam may also be referred to as a spatial filter for transmission, and a reception beam may also be referred to as a spatial filter for reception. A transmission/reception beam may be associated with a sidelink reference signal. For example, a transmission/reception beam may be associated with an index of a sidelink synchronization signal block (SL SSB), and/or a transmission/reception beam may be associated with a resource index of a sidelink channel state information reference signal (SL CSI-RS). Transmission/reception beams associated with different indices may be in the same direction or different directions.

After the PC5-RRC connection is established, it may be considered that an initial beam pair is established between the TX UE and the RX UE. Then, the beam pair may be optimized and maintained through a beam management procedure. The beam pair refers to that, for each transmission beam of the TX UE, there is a paired reception beam at the RX UE side. When the TX UE transmits the PSCCH/PSSCH, the RX UE may use the reception beam paired with the transmission beam used by the TX UE to receive the PSCCH/PSSCH transmitted by the TX UE.

In the present disclosure, if not specifically described, the UE is assumed to have a beam symmetry property. That is, the reception beam and transmission beam of the UE have a symmetry characteristic. Each reception beam of the UE has a transmission beam symmetrical to the reception beam. The reception beam and the transmission beam symmetrical to the reception beam have the same direction, and the reception beam and the transmission beam asymmetrical to the reception beam have different directions. The beam symmetry property can bring great convenience to beam management. For example, according to the beam pair for the PSSCH/PSCCH transmitted from the TX UE to the RX UE, the beam pair for the PSSCH/PSCCH transmitted from the RX UE to the TX UE in a reverse direction may be determined. The beam symmetry property further makes an autonomous resource allocation possible. According to the sensing result in the direction of one reception beam, the UE may autonomously allocate a resource for the PSSCH/PSCCH in the direction of the transmission beam symmetrical to the reception beam.

Further, in the present disclosure, for ease of description, a transmission beam and a reception beam that are symmetrical to each other have the same index (index value). That is, the transmission beam TxBeam #i is symmetrical to the reception beam RxBeam #i. In other words, the transmission beam TxBeam #i is in the same direction as the reception beam RxBeam #i. For example, assuming that the optimal transmission beam for the PSSCH/PSCCH transmitted by the TX UE to the RX UE is TxBeam #i, and the optimal reception beam used by the RX UE to receive the PSSCH/PSCCH transmitted by the TX UE is RxBeam #j, then, the optimal transmission beam for the reverse PSSCH/PSCCH transmitted by the RX UE to the TX UE is the transmission beam TxBeam #j symmetrical to RxBeam #j, and the optimal reception beam used by the TX UE to receive the reverse PSSCH/PSCCH transmitted by the RX UE is the reception beam RxBeam #i symmetrical to TxBeam #i. Here, TxBeam #i and RxBeam #i are the transmission beam and reception beam of the TX UE that are symmetrical to each other, and TxBeam #j and RxBeam #j are the transmission beam and reception beam of the RX UE that are symmetrical to each other. Moreover, TxBeam #i of the TX UE and RxBeam #j of the RX UE are the beam pair for the PSSCH/PSCCH that is transmitted by the TX UE to the RX UE, and RxBeam #i of the TX UE and TxBeam #j of the RX UE are the beam pair for the reverse PSSCH/PSCCH that is transmitted by the RX UE to the TX UE.

According to the present disclosure, the objective of the resource allocation procedure is to determine a resource subset S_{Ai} corresponding to a specified transmission beam TXBeamᵢ. That is, on any sidelink resource in the resource subset S_{Ai} determined by the UE, the UE can transmit the PSSCH/PSCCH using only the corresponding transmission beam TXBeamᵢ, and cannot transmit the PSSCH/PSCCH using other transmission beams. In a slot n, the UE may determine a resource subset S_{Ai} corresponding to a transmission beam TXBeamᵢ, or the UE may determine resource subsets S_{Ai} corresponding to each of a plurality of transmission beams TXBeamᵢ. Here, i is the index of a transmission beam, and 0≤i<N, N being the number of all the transmission beams supported by the UE.

In a resource allocation, the UE determines a respective resource subset S_{Ai} corresponding to one or more transmission beams TXBeamᵢ.

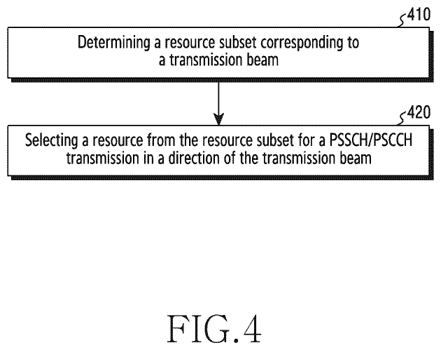

FIG. 4 illustrates a flow diagram of a method for allocating a resource according to various embodiments of the present disclosure. Specifically, a method for allocating a sidelink resource by the UE includes the following steps. In step 410, a resource subset S_{Ai} corresponding to a transmission beam TXBeamᵢ is determined. In step 420, one or more resources are selected from the resource subset S_{Ai} for a PSSCH/PSCCH transmission in the direction of the transmission beam TXBeamᵢ. The procedure of determining a resource subset corresponding to a transmission beam is the procedure of allocating a resource for the transmission beam.

In an embodiment, determining the resource subset S_{Ai} corresponding to the transmission beam TXBeamᵢ may include determining, by the UE, a resource subset corresponding to a transmission beam at a time, the transmission beam being provided by a higher layer (i.e., MAC layer) of the UE. For example, the higher layer of the UE requests a physical layer to determine the resource subset S_{Ai} corresponding to the transmission beam TXBeamᵢ, selects a resource for a PSSCH/PSCCH transmission from the resource subset S_{Ai}, and transmits the PSSCH/PSCCH using the transmission beam. To trigger this procedure, the higher layer may provide the transmission beam TXBeamᵢ related to this PSSCH/PSCCH transmission to the physical layer in, for example, a slot n. Here, i is the index of the beam, and 0≤i<N, N being the number of all the transmission beams supported by the UE. In this situation, the UE needs to determine the transmission beam TXBeamᵢ for the PSSCH/PSCCH transmission in advance. Since the transmission beam is determined in advance, the autonomous resource allocation procedure of the physical layer is simpler, since only a resource subset S_{Ai} needs to be determined.

In an embodiment, determining the resource subset S_{Ai} corresponding to the transmission beam TXBeamᵢ may include determining, by the UE, a resource subset corresponding to each transmission beam in a set of transmission beams at a time respectively. The set of transmission beams are provided by the higher layer of the UE. For example, the higher layer (MAC layer) of the UE requests the physical layer to determine a resource subset set [symbol] {S [symbol] _{Ai}} corresponding to a set of candidate transmission beams {TXBeamᵢ}, selects a transmission beam TXBeamᵢ for a PSSCH/PSCCH transmission from the set of candidate transmission beams {TXBeamᵢ}, and then selects a resource for the PSSCH/PSCCH transmission from the corresponding resource subset S_{Ai}. Here, the higher layer is a medium access control (MAC) layer. To trigger this procedure, the higher layer may provide the set of candidate transmission beams {TXBeamᵢ} related to this PSSCH/PSCCH transmission to the physical layer in, for example, a slot n. The number of the beams contained in the set of candidate transmission beams may be predefined, preconfigured, identified or determined by the MAC layer of the UE itself, and the number of the beams contained in the set of candidate transmission beams is less than the number of all the transmission beams supported by the UE. In this situation, the UE does not need to determine the transmission beam for the PSSCH/PSCCH transmission in advance, but only needs to determine the set of candidate transmission beams for the PSSCH/PSCCH transmission in advance. Accordingly, the flexibility of the transmission beam can be ensured, and at the same time, the complexity of the resource allocation procedure can be taken into consideration.

In an embodiment, determining the resource subset S_{Ai} corresponding to the transmission beam TXBeamᵢ may include determining, at a time, a resource subset corresponding to each transmission beam supported by the UE respectively. For example, in a slot n, the higher layer (MAC layer) of the UE requests the physical layer of the UE to determine a resource subset. For the request of the higher layer, the physical layer of the UE may determine a resource subset S_{Ai} corresponding to each transmission beam TXBeamᵢ in all transmission beams, and report all resource subsets to the higher layer. For example, assuming that the UE supports N transmission beams, the UE needs to determine N corresponding resource subsets S_{Ai} separately. The higher layer of the UE determines a transmission beam TXBeamᵢ for the PSSCH/PSCCH from all the transmission beams, and then selects a resource from the resource subset S_{Ai} corresponding to the transmission beam TXBeamᵢ. In this situation, the UE does not need to limit a transmission beam that may be used for the PSSCH/PSCCH transmission, thereby ensuring the absolute flexibility of the transmission beam.

In an embodiment, when the physical layer of the UE performs a re-evaluation or pre-emption procedure on a resource, it is required to determine the transmission beam corresponding to the resource. That is, the re-evaluation or pre-emption procedure is performed on the resource specifying the transmission beam. For example, the higher layer of the UE requests the physical layer to determine a resource subset to select a resource for a PSSCH/PSCCH transmission, which may be part of the re-evaluation or pre-emption procedure. In a slot n, the higher layer of the UE provides a set of resources (r₀, r₁, r₂, . . . ) for a re-evaluation and/or a set of resources (r₀′r₁′, r₂′, . . . ) for a pre-emption to the physical layer. The higher layer of the UE may further indicate a corresponding transmission beam for each resource in (r₀, r₁, r₂, . . . ) and/or (r₀′, r₁′, r₂′, . . . ). The higher layer of the UE may also indicate a corresponding transmission beam for the set of resources (r₀,r₁,r₂, . . . ) and/or the set of resources (r₀′, r₁′, r₂′, . . . ), that is, all the resources in the set of resources correspond to the same transmission beam. Alternatively, in the slot n, the higher layer of the UE provides a plurality of sets of resources (r₀,r₁, r₂, . . . ) to the physical layer for the re-evaluation, and indicates to each set of resources a corresponding transmission beam. Alternatively, the higher layer of the UE provides a plurality of sets of resources (r₀′, r₁′, r₂′, . . . ) to the physical layer for the pre-emption, and indicates to each set of resources a corresponding transmission beam.

In an embodiment, the procedure of determining the resource subset S_{Ai} corresponding to the transmission beam TXBeamᵢ by the UE may include at least one of: (1) selecting, for the transmission beam TXBeamᵢ, some time units from a resource selection window as candidate time units, where resources on the candidate time units are candidate resources; (2) selecting, for the transmission beam TXBeamᵢ, some time units from a resource sensing window as sensing time units; (3) determining time units sensed using a second reception beam RXBeamⱼ (j≠i) as unsensed time units, and excluding, in case that the periodic resource corresponding to this time unit overlaps with the periodic resource corresponding to a candidate resource, the candidate resource from an initial set of candidate resources, where the direction of the second reception beam RXBeamⱼ is different from the direction of the transmission beam TXBeamᵢ, or the direction of the second reception beam RXBeamⱼ is opposite to the direction of the transmission beam TXBeamᵢ; or (4) determining, in case that sidelink control information SCI (the SCI indicating a reserved resource, and the periodic resource corresponding to the reserved resource indicated by the SCI overlapping with the periodic resource corresponding to a candidate resource) is received at sensing time unit, a RSRP threshold value according to a reception beam receiving the SCI, and excluding, in case that a RSRP value measured based on this SCI is greater than the threshold value, the candidate resource from the initial set of candidate resources.

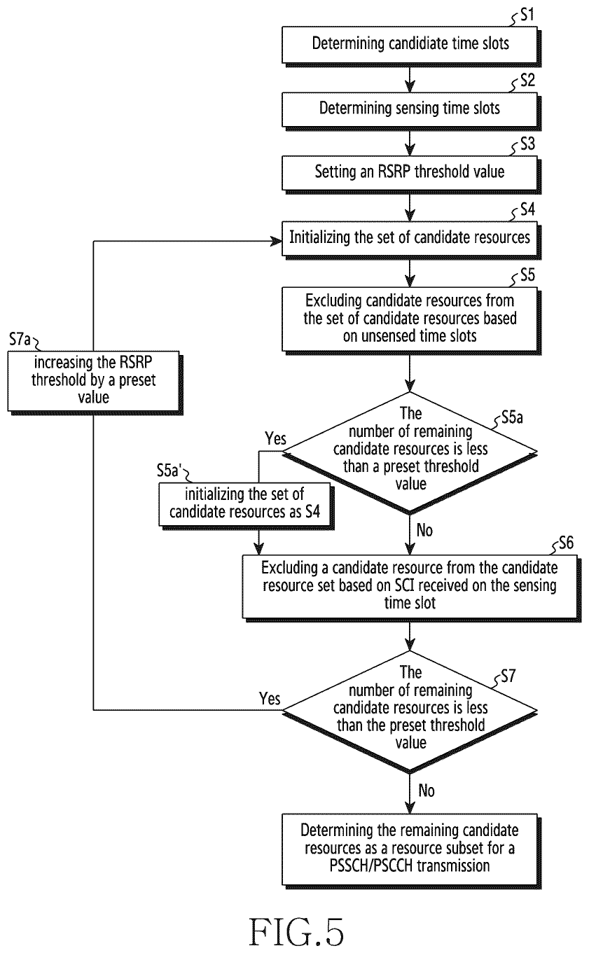

FIG. 5 illustrates a flowchart of a method for allocating a resource according to various embodiments of the present disclosure. An exemplary method for allocating a resource according to the present disclosure is described below in combination with FIG. 5.

In step S1, a UE determines candidate time units for selecting initial candidate resources, and determines candidate resources in the candidate time units. Specifically, for a transmission beam TXBeamᵢ, all or some of time units in a resource selection window are selected as candidate time units, and resources in the candidate time units are candidate resources. All the candidate resources in the candidate time units constitute an initial set of candidate resources. The candidate resources meeting a preset condition are excluded from the initial set of candidate resources, and the remaining candidate resources constitute a resource subset S_{Ai} determined for the transmission beam TXBeamᵢ. The “time unit” here may be, for example, a slot, a sub-slot, or a symbol. For example, the candidate time unit may be a candidate slot, and the candidate resource in the candidate slot may be referred to as a candidate slot resource or a candidate single-slot resource R_{x,y}. Here, R_{x,y} is defined as L_{subCH} contiguous sub-channels in a slot t′_{y}^{SL}, and the corresponding L_{subCH} sub-channel indices are x+j, where j=0, . . . , L_{subCH}−1. Here, the total number of initial candidate single-slot resources may be denoted by Mₜₒₜₐₗ. Hereinafter, for convenience, the description is performed by taking the “slot” as an example of the “time unit.” It should be understood that the time unit in the present disclosure is not limited to the slot, and may refer to other time units, including, but not limited to, the sub-slot and the symbol.

The resource selection window may, for example, be the same as the resource selection window [n+T₁, n+T₂] used during the Mode2 resource allocation, where T₁ and T₂ are values counted according to slots. The UE selects a value from the range 0≤T₁≤T_{proc,1}^{SL} as the value of T1 based on an implementation, T_{proc,1}^{SL} being a predefined value. In case that a remaining packet delay budget is greater than a predefined value T₂ₘᵢₙ he UE selects a value from the range T₂ₘᵢₙ≤T₂≤remaining packet budget as the value of T2, otherwise the value of T2 is set to the remaining packet delay budget.

In step S2, the UE determines the sensing slots. Specifically, for the transmission beam TXBeamᵢ, all or some slots in a resource sensing window are selected as the sensing slots. The sensing result on the sensing slots is used to exclude the candidate resource meeting the preset condition from the initial set of candidate resources. The resource sensing window may, for example, be the same as the resource sensing window [n−T₀, n−T_{proc,0}^{SL}, used during the Mode2 resource allocation, where T₀ and T_{proc,0}^{SL} are both predefined values.

In step S3, the UE sets an RSRP threshold value. For example, an initial RSRP threshold value Th(pᵢ, pⱼ) may be set, which is indicated by the i-th filed of a preconfigured parameter sl-Thres-RSRP-List, where i=pᵢ+(pⱼ−1)*8.

In step S4, the resource subset is initialized to the set of all candidate resources determined in step S1.

In step S5, the UE excludes candidate resource(s) from the initial set of candidate resources based on the unsensed slot(s) among the sensing slots. Specifically, in case that a slot is not sensed since the UE is performing a transmission, and in case that a periodic resource corresponding to this slot overlaps with a periodic resource corresponding to a candidate slot, the candidate resource may be excluded from the initial set of candidate resources. Alternatively, in case that a slot is sensed using a reception beam RXBeamⱼ (j≠i) having a direction different from that of the transmission beam TXBeamᵢ(i.e., the transmission beam TXBeamᵢ is asymmetrical to the reception beam RXBeamⱼ), this slot may be regarded as an unsensed slot. That is, in case that a periodic resource corresponding to this slot overlaps with a periodic resource corresponding to a candidate slot, the candidate resource may also be excluded from the initial set of candidate resources. For example, in case that the periodic candidate resource

$${t}_{m + q \times {P}_{rsvp \_ RX}^{′}}^{′ SL}$$

corresponding to a slot t′ₘ^{SL} overlaps with the periodic resource

$${R}_{x , y + j \times {P}_{{rsvp}_{TX}}^{′}}$$

corresponding to a candidate resource R_{x,y}(q=1, 2, . . . , Q, and j=0, 1, . . . , Cᵣₑₛₑₗ−1), the candidate resource R_{x,y} may be excluded. Here, P_{rsvp_RX}′ refers to the number of logical slots (e.g., sidelink slots) converted based on P_{rsvp_RX}, and P_{rsvp_TX}′ refers to the number of logical slots (e.g., sidelink slots) converted based on P_{rsvp_TX}. Here, P_{rsvp_RX} refers to a resource reservation interval allowed by a higher-layer parameter sl-ResourceReservePeriodList, P_{rsvp_TX} refers to a resource reservation interval indicated by the higher layer for this resource allocation, and the conversion formula is

$${P}_{rsvp}^{′} = ⌈ \frac{{T}_{max}^{′}}{10240 ms} \times {P}_{rsvp} ⌉ ,$$

T′ₘₐₓing a total number of sidelink slots within 10240 ms.

In step S5a, in case that the number of candidate resources remained after the resource exclusion performed in step S5 is less than a preset threshold value, the resource subset is initialized in step S5a′ to the set of all the candidate resources determined in step S1, as in step S4.

In step S6, the UE excludes candidate resource(s) from the current set of candidate resources based on the sidelink control information (SCI) received in the sensing slots. For example, in case that the number of the candidate resources remained after the resource exclusion performed in step S5 is less than the preset threshold value, candidate resource(s) may be excluded from the initial set of candidate resources. In case that the number of the candidate resources remained after the resource exclusion performed in step S5 is not less than the preset threshold value, candidate resource(s) may be excluded from the set of the currently remaining candidate resources. Specifically, in case that the SCI (the SCI indicating a reserved resource, and the periodic resource corresponding to the reserved resource indicated by the SCI overlapping with the periodic resource corresponding to a candidate resource) is received in a sensing slot, and in case that a RSRP value measured based on this SCI is greater than a preset RSRP threshold value, the candidate resource(s) may be excluded from the initial set of candidate resources. The preset RSRP threshold value may be, for example, Th(prio_{RX}, prio_{TX}), Th(prio_{RX}, prio_{TX}) provided by the preconfigured parameter sl-Thres-RSRP-List. Here, prio_{TX} refers to the priority value of a PSSCH/PSCCH transmission indicated by the higher layer of the UE for this resource allocation, and prio_{RX} refers to the priority value indicated in the received SCI. Alternatively, a corresponding RSRP threshold value (Th(prio_{RX}, prio_{TX})+D_{i,j}) or Th(prio_{RX}, prio_{TX})−D_{i,j} is determined according to a reception beam receiving the SCI. Here, i is the index of the transmission beam TXBeamᵢ, and j is the index of the reception beam of the SCI. For example, in case that the periodic candidate resource

$${t}_{m + q \times {P}_{rsvp \_ RX}^{′}}^{′ SL}$$

corresponding to the SCI received in a slot t′ₘ^{SL} overlaps with the periodic resource R_{x,y+j×P}_{_{rsvpTX}}_{′} corresponding to a candidate resource R_{x,y} (q=1, 2, . . . , Q, and j=0, 1, . . . , Cᵣₑₛₑₗ−1), the candidate resource R_{x,y} may be excluded. Here, P_{rsvp_RX}′ refers to the number of logical slots (sidelink slots) converted based on P_{rsvp_RX}, and P_{rsvp_RX}′ refers to the number of logical slots (sidelink slots) converted based on P_{rsvp_TX}. Here, P_{rsvp_RX} refers to a resource reservation interval indicated in the SCI, P_{rsvp_TX} refers to a resource reservation interval indicated by the higher layer for this resource allocation, and the conversion formula is

$${P}_{rsvp}^{′} = ⌈ \frac{{T}_{max}^{′}}{10240 ms} \times {P}_{rsvp} ⌉ ,$$

T′ₘₐₓ being a total number of sidelink slots within 10240 ms.

In step S7, in case that the number of candidate resources remained after the resource exclusion performed in step S6 is less than the preset threshold value, an RSRP threshold value Th(pᵢ, pⱼ) corresponding to each priority value is increased by a predetermined value (e.g., 3 dB) in step S7a, and the procedure continues with step S4.

In case that the number of the candidate resources remained after the resource exclusion performed in step S6 is not less than the preset threshold value, this resource allocation is ended, and the set of the remaining candidate resources is the determined resource subset for the PSSCH/PSCCH transmission.

It should be understood that the method for allocating a resource according to the present disclosure is not limited to the steps described in combination with the example shown in FIG. 5, but may include only some of the steps therein, or may include more steps. Also, the steps described herein are not limited to being performed in the described order, and may be performed in a different order.

In an alternative embodiment, the method for allocating a resource according to the present disclosure may include the procedure described in one or more of the above steps. However, in other steps, the method may not be performed according to the procedure described in the above steps, but instead the method may be performed by using, for example, the corresponding steps in the Mode2 resource allocation. For example, the initial set of candidate resources and/or the sensing slots may be determined according to step 1 and step 2 in the Mode2 resource allocation, and in the subsequent resource exclusion, at least one of step S5 and step S6 described above is used, or a combination of step 5 and/or step 6 in the Mode2 resource allocation and step S5 and/or S6 is used. In an alternative embodiment, step S5 and step S6 may be performed either or both. In the situation where both steps S5 and S6 are performed, the order in which the two steps are performed may be different from the described order, or the two steps may be performed synchronously. As another example, the procedure described in steps S1 and S2 may be used to determine the initial set of candidate resources and/or the sensing slots, and in the resource exclusion, step 5 and/or step 6 in the Mode2 resource allocation may be used, or a combination of step 5 and/or step 6 in the Mode2 resource allocation and step S5 and/or S6 may be used.

Next, the above steps are further described in detail.

There are many ways to select some slots from a resource selection window as candidate slots for a transmission beam.

In an embodiment, for a resource allocation for the PSSCH/PSCCH transmission of a transmission beam TXBeamᵢ, the UE may select some slots from a resource selection window as candidate slots corresponding to the transmission beam TXBeamᵢ. That is, only the sub-channels in some slots can be used as the candidate resources corresponding to the transmission beam TXBeamᵢ.

In an embodiment, each transmission beam in a set of transmission beams may correspond to one slot or a set of consecutive slots sequentially and periodically. The slots corresponding to the transmission beam within the resource selection window may be selected as candidate slots. When each transmission beam in a set of transmission beams corresponding to a set of consecutive slots sequentially and periodically, all slots in the set of consecutive slots are corresponding to the same transmission beam.

In an embodiment, when each transmission beam in a set of transmission beams is corresponding to one slot or a set of consecutive slots sequentially and periodically, the slots corresponding to the transmission beam may include sidelink slots and non-sidelink slots. In another embodiment, when each transmission beam in a set of transmission beams is corresponding to one slot or a set of consecutive slots sequentially and periodically, the slots corresponding to the transmission beam may include only the sidelink slots. Herein, a sidelink slot is a slot that can be used for a PSSCH/PSCCH transmission (i.e., a slot determined according to a sidelink resource pool configuration), and does not include a slot that cannot be used for the PSSCH/PSCCH transmission (i.e., a slot not belonging to the sidelink resource pool, a slot for a PSBCH transmission, a slot for reservation, or a slot in which at least one orthogonal frequency division multiplexing (OFDM) symbol is not configured as an uplink symbol). That is, the sidelink slot does not include at least one of: a slot for the PSBCH transmission, a slot in which at least one OFDM symbol is configured as an uplink symbol, a reserved slot, or a slot not included in the sidelink resource pool.

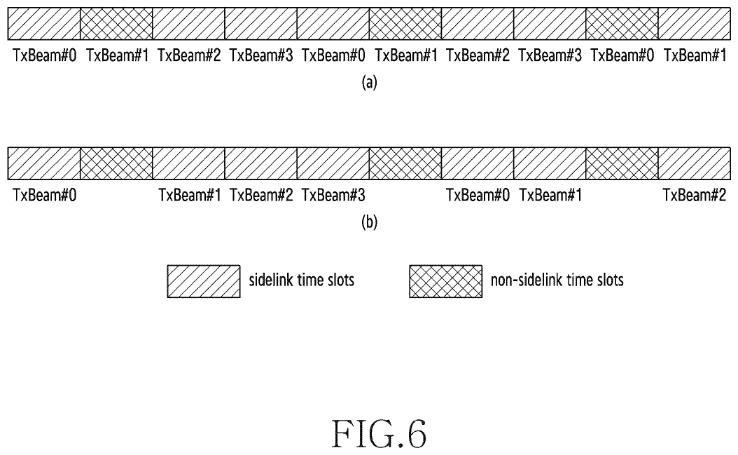

FIG. 6 illustrates an exemplary mapping relationship between transmission beams and slots according to various embodiments of the present disclosure. For example, a slot in the resource selection window and a transmission beam have a one-to-one mapping relationship. That is, each slot is mapping to one transmission beam. In one slot, the UE can only transmit a PSSCH/PSCCH using the corresponding transmission beam and cannot transmit the PSSCH/PSCCH using other transmission beams. A simple and effective corresponding relationship is that each slot is mapped to a different transmission beam sequentially and periodically. That is, a plurality of transmission beams is sequentially and periodically mapped to each slot. As shown in FIG. 6, the UE maps the transmission beams to each slot sequentially and periodically according to the order {#0, #1, #2, #3}, wherein TxBeam #0, TxBeam #1, TxBeam #2 and TxBeam #3 represent four different transmission beams respectively (i.e., being mapped to four different TX spatial filters). The four transmission beams may be all transmission beams supported by the UE, or the four transmission beams may be some of the transmission beams supported by the UE. The UE may determine candidate slots for a transmission beam TXBeamᵢ according to the mapping relationship between the transmission beams and the slots.

There may be two implementations in FIG. 6. In (a), the UE maps the transmission beams to physically consecutive slots according to the order {#0, #1, #2, #3} sequentially and periodically. The “physically consecutive slots” refer to that all slots (including sidelink slots and non-sidelink slots) are mapped to the transmission beams. In (b), the UE maps the transmission beams to logically consecutive slots according to the order {#0, #1, #2, #3} sequentially and periodically. The “logically consecutive slots” refer to that only sidelink slots are mapped to the transmission beams.

In an embodiment, a mapping relationship between slots in a resource selection window and transmission beams is that each transmission beam in a set of transmission beams is mapped to a set of consecutive slots sequentially and periodically. For example, it is assumed that M consecutive slots form a set of slots, the set of slots including M consecutive slots are mapped to the same transmission beam, and each set of slots is mapped to a different transmission beam sequentially and periodically. The value of M may be predefined or preconfigured. For example, M may be the maximum number of beam directions supported by the UE. This has the advantage that the UE does not need to switch a transmission beam frequently. That is, a TX UE may transmit PSSCH/PSCCHs in the same beam direction over M consecutive slots to help an RX UE to determine an optimal reception beam. For example, assuming that M is 4, and that the number of transmission beams corresponding to a slot in a resource selection window [n+T₁, n+T₂] is 4, the order of the transmission beams sequentially mapped to the slots in FIG. 6 may be {#0, #0, #0, #0, #1, #1, #1, #1, #2, #2, #2, #2, #3, #3, #3, #3}. Similar to the foregoing, in case that the UE starts mapping the transmission beams to slots from first sidelink slot, the index i of the transmission beam corresponding to the slot with the index y is

$$i = mod ( ⌊ \frac{y}{M} ⌋ , {N}^{′} ) .$$

For example, the slot t′_{y}^{SL} where a candidate slot resource R_{x,y,i} corresponding to TXBeamᵢ is may meet

$$i = mod ( ⌊ \frac{y}{M} ⌋ , {N}^{′} ) ,$$

where 0≤y<T′ₘₐₓ−1n an embodiment, when each transmission beam in a set of transmission beams is mapped to one slot or a set of consecutive slots sequentially and periodically, the transmission beams for mapping to slots in a resource selection window sequentially and periodically are all transmission beams supported by the UE. For example, it is assumed that the UE has 8 transmission beams in total, and the 8 transmission beams are mapped to candidate slots respectively. For example, the UE maps the transmission beams according to the order {#0, #1, #2, #3, #4, #5, #6, #71 to each slot or each set of slots sequentially and periodically. In this case, it can be ensured that, in each transmission beam direction, there is a resource that can be used to transmit a PSSCH/PSCCH.

In an embodiment, when each transmission beam in a set of transmission beams is mapped to one slot or a set of consecutive slots sequentially and periodically, the transmission beams for mapping to slots in a resource selection window sequentially and periodically are some of the transmission beams supported by the UE. For example, it is assumed that the UE has 8 transmission beams in total, and at a time n, the transmission beams for mapping to the slots in the resource selection window sequentially and periodically are only 4 transmission beams in the 8 transmission beams. For example, the 4 transmission beams are TxBeam #0, TxBeam #1, TxBeam #4 and TxBeam #5 respectively. The UE can sequentially map the transmission beams according to the order {#0, #1, #4, #5} to each slot or each set of slots. In this case, the UE only allocates slots to transmission beams currently having a large transmission opportunity for PSSCH/PSCCH transmission, without needing to allocate slots for the PSSCH/PSCCH transmission to all the transmission beams, thereby improving the resource usage efficiency.

In an embodiment, when each transmission beam in a set of transmission beams is mapped to one slot or a set of consecutive slots sequentially and periodically, the transmission beams for mapping to slots in a resource selection window sequentially and periodically are a set of transmission beams provided by a higher layer (MAC layer) of the UE. For example, at a time n, the transmission beams mapped to the slots in the resource selection window are a set of candidate transmission beams {TXBeamᵢ} for the PSSCH/PSCCH transmission that is provided when the MAC layer of the UE requests a resource allocation. The UE maps the transmission beams in the set of candidate transmission beams {TXBeamᵢ} according to an ascending order of indices to each slot or each set of slots sequentially and periodically.

In an embodiment, when each transmission beam in a set of transmission beams is mapped to one slot or a set of consecutive slots sequentially and periodically, if one transmission beam for PSSCH/PSCCH is configured for each PC5-RRC connection, the transmission beams for mapping to slots in a resource selection window sequentially and periodically are a set of transmission beams, wherein each transmission beam is separately configured for PSSCH/PSCCH of one PC5-RRC connection. For example, the UE currently has two PC5-RRC connections in total. The candidate transmission beam preconfigured by the UE for the first PC5-RRC connection and the candidate transmission beam preconfigured by the UE for the second PC5-RRC connection are mapped according to an ascending order of indices to each slot or each set of slots sequentially and periodically.

In an embodiment, when each transmission beam in a set of transmission beams is mapped to one slot or a set of consecutive slots sequentially and periodically, in case that one set of candidate transmission beams for PSSCH/PSCCH is configured for each PC5-RRC connection, the transmission beams for mapping to slots in a resource selection window are the union set of some sets of candidate transmission beams, wherein each set of candidate transmission beams is separately configured for the PSSCH/PSCCH of one PC5-RRC connection. For example, at a time n, the transmission beams for mapping the slots in the resource selection window sequentially and periodically are the union set of some sets of candidate transmission beams, wherein each set of candidate transmission beams is separately preconfigured by the UE for one current PC5-RRC connection. For example, the UE currently has two PC5-RRC connections in total, the set of candidate transmission beams preconfigured by the UE for the first PC5-RRC connection is {#0, #4, #5}, and the set of candidate transmission beams preconfigured by the UE for the second PC5-RRC connection is {#0, #1, #4}. Then, according to the union set of the two sets of candidate transmission beams, the UE maps the transmission beams according to the order {#0, #1, #4, #5}to each slot or each set of slots sequentially and periodically.

In an embodiment, when the transmission beams are mapped to the slots sequentially and periodically, the mapping may start from a predefined slot. The predefined slot may be, for example, a sidelink slot numbered 0, or the first sidelink slot in the resource selection window. Alternatively, when determining the mapping relationship between slots in the resource selection window [n+T₁, n+T₂] and the transmission beams, the UE may use a specific slot as the starting slot of the mapping. For example, in FIG. 6, the UE maps the transmission beams to the slots from the first sidelink slot. That is, the slot t′₀^{SL} is mapped to TxBeam #0, t′₁^{SL} is mapped to TxBeam #1, t′₂^{SL} is mapped to TxBeam #2, t′₃^{SL} is mapped to TxBeam #3, and so on. In this case, according to the index (index value) of the slot, the UE may determine the index (index value) of the corresponding transmission beam. For example, the slot with the index y is mapped to the transmission beam with the index i=mod(y, N′). Here, N′ is the number of transmission beams used by the UE for mapping to candidate slots sequentially and periodically, for example, N′ is 4 in FIG. 6. Here, the index of the slot may be the physical index of the slot. That is, all slots including sidelink slots and non-sidelink slots are counted. Alternatively, the index of the slot may be the logical index of the slot. That is, only the sidelink slots are counted. For example, the slot t′_{y}^{SL} where the candidate single-slot resource R_{x,y} corresponding to TXBeamᵢ is may meet i=mod(y, N′), where 0≤y<T′ₘₐₓ−1T′ [symbol] _max being a total number of sidelink slots within 10240 ms.

In an embodiment, according to information on a slot corresponding to a transmission beam TXBeamᵢ that is provided by a higher layer of the UE, the slot corresponding to the transmission beam TXBeamᵢ may be selected from a resource selection window as a candidate slot.

A TX UE may have a plurality of PC5-RRC connections at the same time, and the RX UEs corresponding to the plurality of PC5-RRC connections may be positioned in different directions. That is, the plurality of PC5-RRC connections may correspond to different transmission beams of the TX UE. Since the TX UE can only transmit a PSSCH/PSCCH using one transmission beam in a slot, the TX UE may use different transmission beams to transmit the PSSCH/PSCCH for the plurality of PC5-RRC connections in a time-division multiplexing manner. A higher layer of the TX UE may determine, for each transmission beam, a slot in which the PSSCH/PSCCH can be transmitted, and indicate the information to the corresponding RX UE through PC5-RRC signaling, such that the RX UE can use the reception beam paired with the TX UE to monitor the PSCCH in the corresponding slot, thereby avoiding the omission due to the scanning of the reception beam of the RX UE. For example, the TX UE indicates to the RX UE a set of slots in which the reception beam paired with the TX UE needs to be used to monitor the PSCCH. The TX UE may indicate, by means of a bit map, that whether the RX UE needs to use the reception beam paired with the TX UE to monitor the PSCCH in each slot in a period of time. The bit map has periodicity, and the period length is the time length to which the bit map corresponds. A higher layer of the RX UE may transfer this parameter to a physical layer for determining a candidate slot corresponding to a transmission beam when allocating a resource.

Correspondingly, an RX UE may have a plurality of PC5-RRC connections at the same time, and the TX UEs corresponding to the plurality of PC5-RRC connections may be positioned in different directions. That is, the plurality of PC5-RRC connections may correspond to different reception beams of the RX UE. Since the RX UE can only receives a PSSCH/PSCCH using one reception beam in a slot, the RX UE may use different reception beams to monitor the PSCCH for the plurality of PC5-RRC connections in a time-division multiplexing manner. A higher layer of the RX UE may determine, for each reception beam, a preferred slot to monitor the PSCCH, and the RX UE may report the information to the TX UE. For example, the RX UE may indicate to the TX UE a set of slots in which the reception beam paired with the TX UE is used to monitor a PSCCH and which are preferred by the RX UE, such that the TX UE transmits a PSCCH/PSSCH in the set of the slots, thereby avoiding the omission due to the scanning of the reception beam of the RX UE. For example, the RX UE may indicate, by means of a bit map, that whether each slot in a period of time is a reception slot preferred by the RX UE. The bit map has periodicity, and the period length is the time length to which the bit map corresponds. A higher layer of the TX UE may transfer this parameter received from the RX UE to a physical layer for determining a candidate slot corresponding to the transmission beam paired with the RX UE.

In an embodiment, according to the slot sensed by the UE using the reception beam RXBeamᵢ having the same direction as (i.e., symmetrical to) the transmission beam TXBeamᵢ in the resource sensing window, a corresponding slot may be selected from a resource selection window as a candidate slot. For example, in case that a slot n is sensed using the reception beam RXBeamᵢ, slots n+P*k periodically corresponding to the slot n with a preset interval are selected as the candidate slots for the transmission beam TXBeamᵢ, where P is the preset interval and k is a number of the preset intervals.

In an embodiment, the number of candidate slots selected from the resource selection window for the transmission beam TXBeamᵢ may be greater than or equal to a preset number. The preset number may be a preconfigured higher-layer parameter. In case that the number of the candidate slots selected from the resource selection window for the transmission beam TXBeamᵢ is less than the preset number, an additional slot is selected from the resource selection window until the number of the selected candidate slots is greater than or equal to the preset number. For example, the UE selects an additional slot from the resource selection window based on an implementation until the number of the selected candidate slots is greater than or equal to the preset number.

In an embodiment, the ratio of the number of candidate slots selected from a resource selection window for a transmission beam TXBeamᵢ to the number of all sidelink slots in the resource selection window may be greater than or equal to a preset ratio. The preset ratio may be a preconfigured higher-layer parameter. In case that the ratio of the number of the candidate slots selected from the resource selection window for the transmission beam TXBeamᵢ to the number of all the sidelink slots in the resource selection window is less than the preset ratio, an additional slot is selected from the resource selection window until the ratio is greater than or equal to the preset ratio. For example, the UE selects an additional slot from the resource selection window based on an implementation until the ratio of the selected candidate slots is greater than or equal to the preset ratio.

There are many ways to select, for a transmission beam, some slots from a resource sensing window as sensing slots.

In an embodiment, for the resource allocation for the PSSCH/PSCCH transmission using the transmission beam TXBeamᵢ, the UE selects some slots from the resource sensing window as sensing slots corresponding to TXBeamᵢ. In the corresponding sensing slots, the UE may perform sensing using the reception beam RXBeamᵢ symmetrical to TXBeamᵢ. In other words, in the resource sensing window, the slots sensed using the reception beam RXBeamⱼ symmetrical to TXBeamᵢ are selected as the sensing slots corresponding to TXBeamᵢ, and the slots sensed using another reception beam cannot be selected as the sensing slots corresponding to TXBeamᵢ. That is, only the sensing result in the slots sensed using the symmetrical reception beam RXBeamᵢ is used to determine the resource subset S_{Ai} corresponding to TXBeamᵢ.

In an embodiment, all slots in the resource sensing window that are sensed using the reception beam RXBeamᵢ symmetrical to TXBeamᵢ are selected as the sensing slots corresponding to TXBeamᵢ.

In an embodiment, each reception beam in the set of reception beams is mapped to one slot or a set of consecutive slots sequentially and periodically, and the slots corresponding to the reception beam RXBeamᵢ are selected from a selection resource sensing window as candidate slots. When each reception beam in a set of reception beams is mapped to a set of consecutive slots sequentially and periodically, all slots in the set of slots are mapped to the same reception beam.

In an embodiment, when each reception beam in a set of reception beams is mapped to one slot or a set of consecutive slots sequentially and periodically, the slots mapped to the reception beam may include sidelink slots and non-sidelink slots. In another embodiment, when each reception beam in a set of reception beams is mapped to one slot or a set of consecutive slots sequentially and periodically, the slots mapped to the reception beam may include only the sidelink slots.

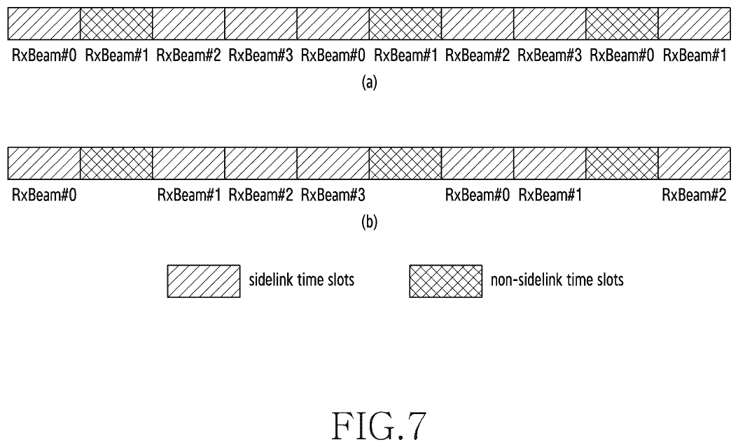

In an embodiment, a slot in the resource selection window and a reception beam used to perform sensing have a one-to-one corresponding relationship. That is, each slot corresponds to one reception beam. In a slot, the UE can only perform the sensing using the corresponding reception beam, and cannot perform the sensing using other reception beams. A simple and effective corresponding relationship is that each slot is mapped to a different reception beam sequentially and periodically. That is, a plurality of reception beams is sequentially mapped to the slots. FIG. 7 illustrates an exemplary corresponding relationship between reception beams and slots according to the present disclosure. As shown in FIG. 7, the UE sequentially cycles reception beams to each slot according to the order {#0, #1, #2, #31, wherein RxBeam #0, RxBeam #1, RxBeam #2 and RxBeam #3 represent four different reception beams respectively (i.e., being mapped to four different RX spatial filters). The four reception beams may be all reception beams supported by the UE, or the four reception beams may be some of the reception beams supported by the UE. The UE may determine, for one slot, a corresponding reception beam for performing sensing according to the corresponding relationship between the reception beams and the slots, and then determine the corresponding sensing slots for TXBeamᵢ.

There may be two implementations in FIG. 7. In (a), the UE maps the reception beams to physically consecutive slots according to the order {#0, #1, #2, #3} sequentially and periodically. The “physically consecutive slots” refer to that all slots (including sidelink slots and non-sidelink slots) are mapped to the reception beams. In (b), the UE maps the reception beams to logically consecutive slots according to the order {#0, #1, #2, #3} sequentially and periodically. The “logically consecutive slots” refer to that only sidelink slots are mapped to the reception beams.

In an embodiment, each reception beam in a set of reception beams is mapped to a set of consecutive slots sequentially and periodically. For example, it is assumed that M consecutive slots form a set of slots, the set of slots including M consecutive slots are mapped to the same reception beam, and each set of slots is mapped to a different reception beam sequentially and periodically. The value of M may be predefined or preconfigured. For example, M may be the maximum number of beam directions supported by the UE. This has the advantage that the UE does not need to switch a reception beam frequently. That is, an RX UE may receive a PSSCH/PSCCH using the same reception beam over M consecutive slots to determine an optimal transmission beam of a TX UE. For example, assuming that M is 4, and the number of reception beams used to sequentially sense a slot is 4, the order of the reception beams mapped to correspond to the slots in FIG. 7 may be {#0, #0, #0, #0, #1, #1, #1, #1, #2, #2, #2, #2, #3, #3, #3, #3}. Similar to the foregoing, if the UE starts mapping the reception beams to the slots from a first sidelink slot, the index of the reception beam corresponding to the slot with the index m is

$$i = mod ( ⌊ \frac{m}{M} ⌋ , {N}^{′} ) .$$

For example, a sensing slot t′ₘ^{SL} corresponding to TXBeamᵢ may meet

$$i = mod ( ⌊ \frac{m}{M} ⌋ , {N}^{′} ) ,$$

where 0≤m<T′ₘₐₓ−1T′ [symbol] _max being a total number of sidelink slots within 10240 ms.

In an embodiment, when each reception beam in a set of reception beams is mapped to one slot or a set of consecutive slots sequentially and periodically, the reception beams for mapping to slots sequentially and periodically may be all reception beams supported by the UE.

For example, it is assumed that the UE has 8 reception beams in total. The UE maps the reception beams according to the order {#0, #1, #2, #3, #4, #5, #6, #7} to perform sensing. This has the advantage that it can be ensured that there is a sensing result in each reception beam direction.

In an embodiment, when each reception beam in a set of reception beams is mapped to one slot or a set of consecutive slots sequentially and periodically, the reception beams mapped to the slots may be some of the reception beams supported by the UE. For example, it is assumed that the UE has 8 reception beams in total, and in a period of time, the UE sequentially performs sensing only using 4 reception beams in the 8 reception beams. Assuming that the 4 reception beams are RxBeam #0, RxBeam #1, RxBeam #4 and TxBeam #5 respectively, the UE may sequentially use the reception beams according to the order {#0, #1, #4, #5} to sense each slot or each set of slots. In this case, the UE only performs sensing in a reception beam direction currently having a large transmission opportunity, without needing to perform sensing in all reception beam directions, thereby improving the sensing efficiency.

In an embodiment, when each reception beam in a set of reception beams is mapped to one slot or a set of consecutive slots sequentially and periodically, the reception beams mapped to the slots sequentially and periodically may be a set of reception beams provided by a higher layer (MAC layer) of the UE. For example, for a candidate set of reception beams {RXBeamᵢ} for the PSSCH/PSCCH transmission that is provided when the MAC layer of the UE requests a resource allocation, the reception beams in the set are mapped to each slot or each set of slots sequentially and periodically according to an ascending order of indices.

In an embodiment, when each reception beam in a set of reception beams is mapped to one slot or a set of consecutive slots sequentially and periodically, if one reception beam for a PSSCH/PSCCH is configured for each PC5-RRC connection, the reception beams mapped to the slots may be the set of the reception beams paired with the transmission beams for the PSSCH/PSCCH that are configured for all PC5-RRC connections of the UE.

In an embodiment, when each reception beam in a set of reception beams is mapped to one slot or a set of consecutive slots sequentially and periodically, in case that a set of candidate reception beams for a PSSCH/PSCCH is configured for each PC5-RRC connection, the reception beams mapped to the slots sequentially and periodically may be the union set of some sets of the set of candidate reception beams, wherein each set of candidate reception beams is separately paired with the set of candidate transmission beams of the PSSCH/PSCCH of one PC5-RRC connection of the UE. It is assuming that the UE currently has two PC5-RRC connections in total, the set of candidate reception beams preconfigured by the UE for the first PC5-RRC connection is {#0, #4, #5}, and the set of candidate reception beams preconfigured by the UE for the second PC5-RRC connection is {#0, #1, #4}. Then, according to the union set of the two sets of candidate reception beams, the UE maps the reception beams to each slot sequentially and periodically according to the order {#0, #1, #4, #5}.

When reception beams are mapped to slots sequentially and periodically, different reception beams are mapped sequentially and periodically to slots from a predefined slot. The predefined slot may be, for example, a sidelink slot numbered 0, or the first sidelink slot in the resource sensing window.

Alternatively, when determining the mapping relationship between slots and reception beams, the UE may use a specific slot as the starting slot for the mapping of the reception beams. For example, in FIG. 7, the UE maps the reception beams to slots from the first sidelink slot. That is, a slot t′₀^{SL} is mapped to RxBeam #0, t′₁^{SL} is mapped to RxBeam #1, t′₂^{SL} is mapped to RxBeam #2, t′₃^{SL} is mapped to RxBeam #3, and so on. In this case, according to the index (index value) of a slot, the UE may determine the index (index value) of the corresponding reception beam. For example, the slot with the index m is mapped to the reception beam with the index i=mod(m, N′). Here, N′ is the number of reception beams used by the UE to be mapped to the slots, for example, N′ is 4 in FIG. 7. Here, the index of the slot may be the physical index of the slot; that is, all slots including sidelink slots and non-sidelink slots are counted. Alternatively, the index of the slot may be the logical index of the slot; that is, only the sidelink slots are counted. For example, a sensing slot t′ₘ^{SL} corresponding to TXBeamᵢ may meet i=mod(m, N′), where 0≤m<T′ₘₐₓ−1T′ [symbol] _max being a total number of sidelink slots within 10240 ms.

In an embodiment, according to information on a slot corresponding to a reception beam RXBeamᵢ that is provided by a higher layer of the UE, the slot corresponding to the reception beam RXBeamᵢ may be selected from a resource sensing window as a sensing slot.

Similar to the above description in which the candidate slot is determined according to the information on the slot corresponding to the transmission beam TXBeamᵢ that is provided by the higher layer of the UE, a TX UE may indicate to an RX UE a set of slots in which the reception beam paired with the TX UE needs to be used to monitor a PSCCH, and the TX UE may indicate, by means of a bit map, that whether the RX UE needs to use the reception beam paired with the TX UE to monitor the PSCCH in each slot in a period of time. The bit map has periodicity, and the period length is the time length to which the bit map corresponds. A higher layer of the RX UE may transfer this parameter received from the TX UE to a physical layer for determining a corresponding sensing slot for the reception beam paired with the TX UE.

Correspondingly, an RX UE may indicate to a TX UE a set of slots in which the reception beam paired with the TX UE is used to monitor a PSCCH and which are preferred by the RX UE, such that the TX UE transmits a PSCCH/PSSCH in the set of the slots, thereby avoiding the omission due to the scanning of the reception beam of the RX UE. For example, the RX UE may indicate, by means of a bit map, that whether each slot in a period of time is a reception slot preferred by the RX UE. The bit map has periodicity, and the period length is the time length to which the bit map corresponds. A higher layer of the RX UE may transfer this parameter to a physical layer for determining a corresponding sensing slot for a transmission beam.

In an embodiment, according to the candidate slot selected from a resource selection window for the transmission beam TXBeamᵢ having the same direction as (i.e., symmetrical to) the reception beam RXBeamᵢ, the corresponding slots may be selected from a resource sensing window as sensing slots. For example, in case that a slot n is the candidate slot selected for the transmission beam, slot n-P*k periodically corresponding to the slot n with a preset interval before the slot n are selected as the sensing slots, where P is the preset interval and k is a number of the preset intervals.

In an embodiment, in the sensing slots determined for the resource allocation for a PSSCH/PSCCH transmission in the direction of a transmission beam, a reception beam having the same direction as the transmission beam may be used to monitor a PSCCH. That is, the reception beam is symmetrical to the transmission beam.

In an embodiment, a slot sensed using a reception beam RXBeamᵢ in the resource sensing window may be selected as a sensing slot.

In an embodiment, the number of sensing slots selected for a reception beam RXBeamᵢ may be greater than or equal to a preset number. The preset number is, for example, a preconfigured higher-layer parameter. In case that the number of the sensing slots selected for the reception beam RXBeamᵢ is less than the preset number, an additional slot is selected from the resource sensing window based on an implementation until the number of the selected sensing slots is greater than or equal to the preset number.

In an embodiment, the ratio of the number of sensing slots selected from a resource sensing window for a reception beam RXBeamᵢ to the number of all sidelink slots in the resource sensing window may be greater than or equal to a preset ratio. The preset ratio is, for example, a preconfigured higher-layer parameter. If the ratio of the number of the sensing slots selected for the reception beam RXBeamᵢ to the number of all the sidelink slots in the resource sensing window is less than the preset ratio, an additional slot is selected from the resource sensing window based on an implementation until the ratio is greater than or equal to the preset ratio.

With respect to the exclusion of a candidate resource, in an embodiment, in case that a slot is sensed using a reception beam RXBeam₁ (j≠i) having a direction different from that of a transmission beam TXBeamᵢ, that is, the reception beam RXBeamⱼ is asymmetrical to the transmission beam RXBeamⱼ, the slot may be regarded as an unsensed slot, and thus is not used as a sensing slot. Accordingly, if the periodic resource corresponding to the slot overlaps with the periodic resource corresponding to a candidate slot, the candidate resource may be excluded from the initial set of candidate resources.

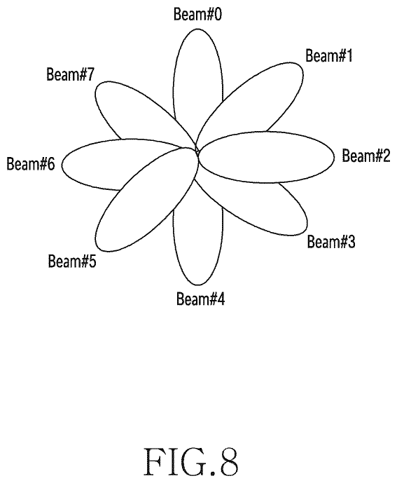

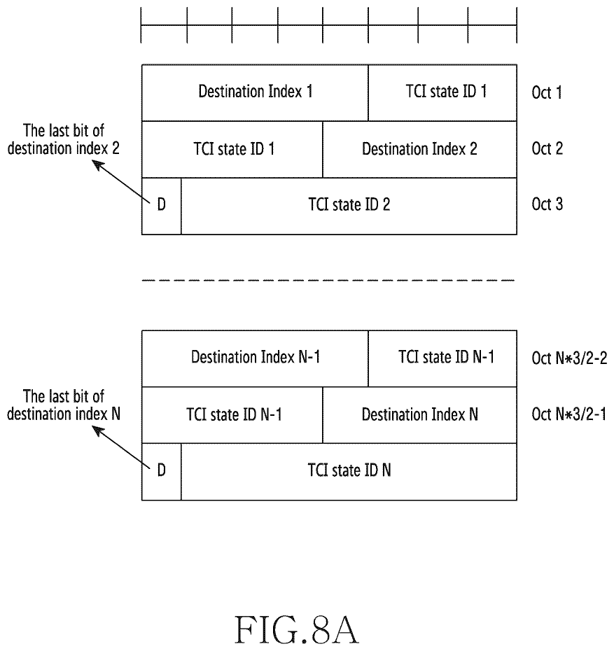

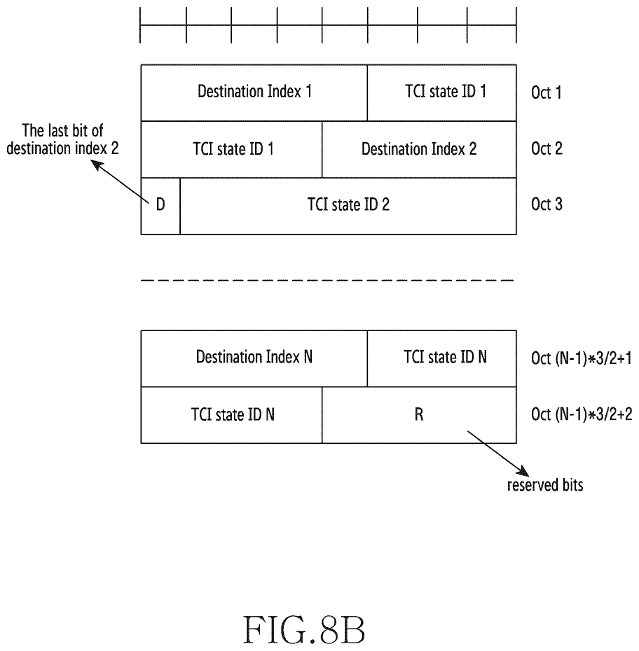

In general, assuming that the UE performs sensing using a reception beam RxBeam #j in a slot, and the sensing result of this slot can only be used for the determination of a resource subset corresponding to the transmission beam TxBeam #i (i.e., j=i) symmetrical to the reception beam, and is meaningless for the determination of a resource subset corresponding to another transmission beam TxBeam #i (i.e., j≠i), which is equivalent to that the slot is not sensed; or the sensing result of this slot can still be used for the determination of the resource subset corresponding to the other transmission beam TxBeam #i, but cannot be used for the determination of a resource subset corresponding to the transmission beam TxBeam #i having a direction completely opposite to that of the beam RxBeam #j. Two beams having completely opposite directions refer to that the two beams the directions of the two beam are rotated 180 degrees from each other. As shown in FIG. 8, the direction of the beam #0 is completely opposite to that of the beam #4, the direction of the beam #1 is completely opposite to that of the beam #5, the direction of the beam #2 is completely opposite to that of the beam #6, and the direction of the beam #3 is completely opposite to that of the beam #7.

In an embodiment, for a resource allocation for the PSSCH/PSCCH transmission of a transmission beam TXBeamᵢ, the reception beam used by the UE to perform sensing in a certain slot is RXBeamᵢ. In case that RXBeam₁ and TXBeamᵢ are not exactly the same in direction (i.e., not symmetrical to each other), where j≠i, it may be considered that the sensing result in this slot has no reference value to the transmission beam TXBeamᵢ, and this slot may be regarded as an unsensed slot. In another embodiment, if RXBeamⱼ and TXBeamᵢ are completely opposite in direction, where j=mod(i, N/2) or j is a preconfigured value corresponding to i (e.g., the index of the reception beam having a direction completely opposite to that of TXBeamᵢ and provided by a higher layer of the UE to a physical layer), it may be considered that the sensing result in this slot is meaningless to the transmission beam TXBeamᵢ, and this slot may be regarded as an unsensed slot. In the above situations, if the resource periodically reserved corresponding to a candidate single-slot resource overlaps with the resource periodically reserved corresponding to this slot, the candidate single-slot resource R_{xy} may be excluded from the initial set of candidate resources.

In an embodiment, if SCI (the SCI indicating a reserved resource, and the periodic resource corresponding to the reserved resource indicated by the SCI overlapping with the periodic resource corresponding to a candidate resource in a resource subset) is received in a sensing slot, a RSRP threshold value may be determined according to a reception beam receiving the SCI. According to the RSRP threshold value, it may be determined whether the candidate resource may be excluded from the initial set of candidate resources. Specifically, if the RSRP value measured based on this SCI is greater than the determined RSRP threshold value, the candidate resource is excluded.

With respect to the determination of the RSRP threshold value, in an embodiment, the RSRP threshold value is determined based on the direction of the reception beam receiving the SCI. If the SCI is received using the reception beam RXBeamⱼ having the same direction as a transmission beam TXBeamᵢ, that is, the transmission beam TXBeamᵢ is symmetrical to the reception beam RXBeamⱼ, a first RSRP threshold value is determined as the corresponding RSRP threshold value. If the RSRP value measured based on this SCI is greater than the first RSRP threshold value, the candidate resource is excluded from the initial set of candidate resources. If the SCI is received using the reception beam RXBeamⱼ having a different direction from that of the transmission beam TXBeamᵢ, that is, the transmission beam TXBeamᵢ is asymmetrical to the reception beam RXBeamⱼ, a second RSRP threshold value different from the first RSRP threshold value is determined as the corresponding RSRP threshold value. If the RSRP value measured based on this SCI is greater than the second RSRP threshold value, the candidate resource is excluded. In other words, the RSRP threshold values used for the exclusion of a candidate resource and corresponding to the SCI received using the reception beams of different directions are different.

In an embodiment, the second RSRP threshold value may be determined based on the first RSRP threshold value. For example, the second RSRP threshold value may be obtained by increasing or decreasing the first RSRP threshold value by a preset amount. The preset amount is Di,j, and may be predefined or preconfigured. Specifically, the value of the offset is related to the index i of the transmission beam TXBeamᵢ and the index j of the reception beam RXBeamⱼ of the SCI. For example, the preset amount Di,j may be configured for different transmission beams i and reception beams j respectively. Here, i is the index value of a transmission beam and j is the index value of a reception beam. Specifically, when i=j, Di,j=0.

In an embodiment, in addition to being related to the reception beam RXBeamⱼ used to receive SCI and the target transmission beam TXBeam for a PSCCH/PSSCH transmission, the RSRP threshold value used for the exclusion of a candidate resource is determined based on whether the transmission beam for the PSSCH/PSCCH on the reserved resource indicated by the SCI is the same as the transmission beam for the SCI. For example, if the SCI is received using the reception beam RXBeam₁ having the same direction as a transmission beam TXBeamᵢ. That is, the transmission beam TXBeamᵢ is symmetrical to the reception beam RXBeamⱼ, a first RSRP threshold value is determined as the corresponding RSRP threshold value. If the SCI is received using the reception beam RXBeamⱼ having a different direction from that of the transmission beam TXBeamᵢ(i.e., the transmission beam TXBeamⱼ is asymmetrical to the reception beam RXBeamⱼ), and the transmission beam for the PSSCH/PSCCH on the reserved resource indicated by the SCI is the same as the transmission beam for the SCI, a third RSRP threshold value different from the first RSRP threshold value is determined as the corresponding RSRP threshold value. If the SCI is received using the reception beam RXBeamⱼ having a different direction from that of the transmission beam TXBeamᵢ(i.e., the transmission beam TXBeamᵢ is asymmetrical to the reception beam RXBeamⱼ), and the transmission beam for the PSSCH/PSCCH on the reserved resource indicated by the SCI is different from the transmission beam for the SCI, a fourth RSRP threshold value different from the first RSRP threshold value is determined as the corresponding RSRP threshold value. Here, the third RSRP threshold value and the fourth RSRP threshold value are also different. In the above situations, if the RSRP value measured based on the SCI is greater than the corresponding RSRP threshold value, the candidate resource is excluded.

In an embodiment, the UE may determine according to an indication in the SCI whether the transmission beam used by another UE on the resource reserved by the SCI is the same as the transmission beam used by the SCI. For example, the SCI may indicate whether the transmission beam for a next transmitted PSSCH/PSCCH is the same as the transmission beam used by the current SCI, or the SCI may indicate the transmission beam for the next transmitted PSSCH/PSCCH.

In an embodiment, according to whether the resource reserved by SCI is within a preset window after the SCI, the UE may determine whether the transmission beam used by another UE on the resource reserved by the SCI is the same as the transmission beam used by the SCI. For example, in case that the resource reserved by SCI is within the preset window after the SCI, it is determined that the two transmission beams are the same, otherwise, it is determined that the two transmission beams are different.

In an embodiment, Mode 1 resource allocation is configured for the transmission resource pool of the UE. The sidelink resources for a PSSCH/PSCCH transmission in the resource pool are allocated by the base station in a centralized manner. The transmission beam corresponding to the PSSCH/PSCCH transmission and reported by the UE to the base station can assist the base station in allocating a resource for the PSSCH/PSCCH. The UE can establish a plurality of PC5-RRC connections at the same time. Accordingly, considering that the transmissions of the UE on the plurality of PC5-RRC connections may correspond to different transmission beams (i.e., different TX spatial filters), the UE may report the transmission beam corresponding to each PC5-RRC connection to the base station. That is, the UE reports the respective transmission beam corresponding to each communication destination to the base station, and the base station allocates sidelink resources in the corresponding beam direction based on the information reported by the UE. This has the advantage that the base station may allocate the same sidelink resource to different UEs for simultaneous use in different beam directions. Due to the directionality of the beam, the PSSCH/PSCCH transmitted in the directions of different beams may not interfere with each other, thereby improving the use efficiency of the sidelink resource and realizing the effect of multiplexing the sidelink resource in the spatial domain. In addition, when requesting sidelink resources from the base station through a scheduling request (SR), the UE may report the transmission beam corresponding to the PSSCH/PSCCH transmission on the requested sidelink resource to the base station.

As an example, the UE reports an optimal transmission beam corresponding to each of one or more communication destinations to the base station through the SL medium access control (MAC) control element (CE), and the UE uses the reported optimal transmission beam to transmit the PSSCH/PSCCH to the corresponding communication destination. Assuming that the sidelink (SL) transmission of the UE can share the same set of TX spatial filters with the uplink (UL) transmission, the transmission beam corresponding to the SL transmission of the UE can be indicated by the transmission beam corresponding to the UL transmission. That is, the UE can associate the sidelink transmission beam with the uplink transmission beam through an implementation. The transmission beam can be indicated by the ID of a sidelink transmission configuration indicator (TCI) state. that is, the UE can associate a SL TCI state ID with a UL TCI state ID through an implementation.

For example, the transmission beam corresponding to the SL transmission of the UE may be indicated by the ID of a UL TCI state, the ID of a joint TCI state, the index of an SSB, the index of an CSI-RS, or the index of a sounding reference signal (SRS). That is, the UE may determine the TX spatial filter corresponding to the PSSCH/PSCCH transmission according to the ID of the UL TCI state, the ID of the joint TCI state, the index of the SSB, the index of the CSI-RS, or the index of the SRS.

As shown in FIGS. 8A and 8B, the UE may report the transmission beams corresponding to the PSSCH/PSCCH transmissions of N communication destinations via the SL MAC CE in an example, where N is a natural number with a minimum of 1 and a maximum of 32. When N is an even number, the SL MAC CE structure is as shown in FIG. 8A. When N is an odd number, the SL MAC CE structure is as shown in FIG. 8B. It is required to include reserved 4 bits at the end of the last byte. Here, a Destination Index refers to the communication destination of a PC5-RRC connection, which is indicated by 5 bits. A TCI state ID refers to the ID of a UL TCI state or the ID of a joint TCI state, which is indicated by 7 bits. The UE can determine the corresponding TX spatial filter for a sidelink transmission according to the reported TCI state ID. When the optimal transmission beam corresponding to the PSSCH/PSCCH transmission of one destination changes, the UE may report the newest optimal transmission beam to the base station in time.

Considering that the optimal transmission beam of the PSSCH/PSCCH of one communication destination may change frequently, the UE may alternatively report a respective set of candidate transmission beams corresponding to one or more communication destinations to the base station through the SL MAC CE, the set of candidate transmission beams including at least two candidate transmission beams. Similar to FIGS. 8A and 8B described above, the SL MAC CE may indicate at least two candidate TCI state IDs for each destination.

As an example, the UE implicitly reports the transmission beam corresponding to the transmission on the requested sidelink resource to the base station through a different SL SR configuration. For example, the base station provides the UE with a plurality of SL SR configurations for requesting a PSSCH/PSCCH transmission resource, each SL SR configuration corresponding to a different transmission beam. That is, the base station provides the UE with a plurality of PUCCH resources for an SL SR transmission on each UL bandwidth portion (BWP), each PUCCH resource corresponding to a different transmission beam. If the UE triggers the SL SR, the SL SR may be transmitted using the PUCCH resource corresponding to a target transmission beam. For example, when configuring a PUCCH resource for an SL SR transmission for the UE, the base station further indicates to the PUCCH resource associated transmission beam information.

As an example, when allocating a sidelink resource for a PSSCH/PSCCH transmission to the UE, the base station needs to indicate the transmission beam corresponding to this PSSCH/PSCCH transmission. That is, on the allocated sidelink resource, the UE can only transmit the PSSCH/PSCCH using the indicated transmission beam (TX spatial filter), and cannot transmit the PSSCH/PSCCH using other transmission beams (TX spatial filters). For example, the base station indicates the transmission resource of the PSSCH/PSCCH to the UE through DCI, and the DCI includes the information of the transmission beam for the PSSCH/PSCCH transmission. The base station may further preconfigure a sidelink grant for the UE. For a Type 1 preconfigured grant, the base station includes corresponding transmission beam information in the RRC configuration information of the transmission resource of the PSSCH/PSCCH. For a Type 2 preconfigured grant, the base station includes corresponding transmission beam information in the activation DCI of the PSSCH/PSCCH transmission.

The transmission beam information of the PSSCH/PSCCH transmission in the above example may be indicated by the ID of a UL TCI state, the ID of a joint TCI state, the index of an SSB, the index of an CSI-RS, the index of an SRS, the index of an SL SSB, or the index of an SL CSI-RS.

In the present disclosure, the mentioned transmission beam may be indicated by a sidelink transmission configuration indicator (SL TCI) state identifier (ID). The signal corresponding to the same SL TCI state ID may be understood to be transmitted by the TX UE from the same TX spatial filter, and the RX UE may receive the signal using the same RX spatial filter. The RX UE may determine the used RX spatial filter according to the TCI state ID of the PSSCH/PSCCH transmission that is indicated by the TX UE. For example, with reference to the TCI framework used in the communication system of the UU interface, the SL TCI may indicate that the DMRS of the PSSCH/PSCCH and one baseline sidelink reference signal have a quasi-colocated (QCL) characteristic in terms of large-scale parameter, and the baseline sidelink reference signal may be an SL SSB or SL CSI-RS.

QCL refers to that the antenna ports of two quasi-colocated physical signals have the same large-scale parameter, that is, the large-scale parameter of the radio channel experienced by the PSSCH/PSCCH can be measured from a QCL baseline reference signal. According to the type of the large-scale parameter, QCL can be divided into four types: Type A, Type B, Type C and Type D. The QCL Type A refers to that two antenna ports have the same delay spread, Doppler spread, Doppler shift and average delay. The QCL Type B refers to that two antenna ports have the same Doppler spread and Doppler shift. The QCL Type C refers to that two antenna ports have the same Doppler shift and average delay. The QCL Type D refers to that two antenna ports have the same spatial Rx parameter. Here, the QCL Type A, the QCL Type B and the QCL Type C can be used for all frequency bands, but the QCL Type D is used only for FR2, which means that the signals of the two antenna ports are transmitted using the same beam (i.e., transmitted using the same TX spatial filter), and the receiver can receive the signals using the same reception beam.

Each SL TCI state may indicate the index of an associated baseline sidelink reference signal (e.g., the index of an SL SSB or SL CSI-RS), and indicate the QCL type (one of Type A, Type B, Type C and Type D) associated with this baseline sidelink reference signal. Alternatively, each SL TCI state may indicate only the index of the associated baseline sidelink reference signal (e.g., the index of the SL SSB or SL CSI-RS), and the QCL relationship associated with this baseline sidelink reference signal defaults to Type D.

In addition to the SL TCI state, the transmission beam for the PSSCH/PSCCH transmission may also be indicated by the index of an SL SSB or SL CSI-RS. For example, the DMRS of PSCCH/PSSCH is associated with a baseline sidelink reference signal, and the QCL relationship associated with the baseline sidelink reference signal defaults to Type D. Here, the baseline sidelink reference signal may be an SL SSB or SL CSI-RS.

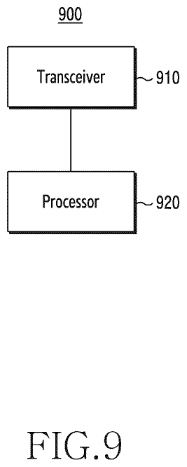

The above method described in the present disclosure may be performed by a UE including a transceiver and a processor. FIG. 9 illustrates an exemplary structure of a UE 900 according to the present disclosure. As shown in FIG. 9, the UE 900 includes a transceiver 910, and a processor 920 coupled to the transceiver 910. The transceiver 910 is configured to transmit and receive a signal. The processor 920 is configured to perform one or more of the operations described above in combination with the specific embodiments, thereby causing the UE to perform the method for allocating a resource described in the present disclosure. For example, the processor 920 is configured to determine a resource subset corresponding to a transmission beam; and select one or more resources from the determined resource subset for a PSSCH/PSCCH transmission in a direction of the transmission beam.

The present disclosure may alternatively be implemented as a computer storage medium. The computer storage medium stores a computer instruction. The computer instruction, when executed by the processor 920 in the UE 900, causes the processor 920 to perform one or more of the operations described above in combination with the specific embodiments, thereby implementing the method for allocating a resource described in the present disclosure.

It can be understood that “at least one” described in the present disclosure includes any and/or all possible combinations of the listed items, the various embodiments described in the present disclosure and the various examples in the embodiments may be varied and combined in any suitable form, and “/” described in the present disclosure represents “and/or.”

The various illustrative logical blocks, modules, and circuits described in the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. The general purpose processor may be a microprocessor, but in an alternative scheme, the processor may be any conventional processor, controller, microcontroller, or state machine. The processor may alternatively be implemented as a combination of computing devices, for example, a combination of a DSP and a microprocessor, a plurality of microprocessors, one or more microprocessors in collaboration with a DSP core, or any other such configuration.

The steps of the method or algorithm described in the present disclosure may be embodied directly in hardware, in a software module executed by the processor, or in a combination of the two. The software module may reside in a RAM memory, a flash memory, a ROM memory, an EPROM memory, an EEPROM memory, a register, a hard disk, a removable disk, or any other form of storage medium known in the art. An exemplary storage medium is coupled to the processor, to enable the processor to read information from/write information to the storage medium. In an alternative scheme, the storage medium may be integrated to the processor.

The processor and the storage medium may reside in an ASIC. The ASIC may reside in a user terminal. In an alternative scheme, the processor and the storage medium may reside as discrete components in a user terminal.

In one or more exemplary designs, the functions described may be implemented in hardware, software, firmware, or any combination thereof. If implemented in software, the functions may be stored on or transmitted over a computer readable medium as one or more instructions or code. The computer readable medium includes both a computer storage medium and a communication medium, the communication medium including any medium that facilitates the transfer of a computer program from one place to another. The storage medium may be any available medium that can be accessed by a general purpose or special purpose computer.

Example configurations, methods and apparatuses are described in combination with the accompanying drawings in description set forth herein, and do not represent all the examples that may be implemented or that are within the scope of the claims. The term “exemplary” used herein means “serving as an example, instance, or illustration,” rather than “preferred” or “advantageous over other examples.” The detailed description includes specific details for the purpose of providing an understanding of the described techniques. These techniques, however, may be practiced without these specific details. In some instances, well-known structures and devices are shown in the form of a block diagram in order to avoid obscuring the concepts of the described examples.

This specification contains many specific implementation details, but the implementation details should not be construed as a limitation to the scope of any disclosure or the scope claimed, but rather as a description for specific features in a specific embodiment of the specific disclosure. Certain features described in the context of separate embodiments in this specification may alternatively be implemented in combination in a single embodiment. Rather, the various features described in the context of a single embodiment may be implemented separately in a plurality of embodiments or implemented in any suitable sub-combination.

Furthermore, the features may be described as functioning in certain combinations in the context, and even initially so claimed, but in some cases one or more features in a claimed combination may be deleted from the combination, and the claimed combination may be directed to a sub-combination or the variation of the sub-combination.

It is to be understood that the specific order or hierarchy of steps in the method in the present disclosure is an illustration for an exemplary procedure. Based on design preferences, it may be understood that the specific order or hierarchy of the steps in the method may be rearranged to achieve the functions and effects disclosed in the present disclosure. The accompanying method claims present the elements of various steps in example order, but are not intended to be limited to the specific order or hierarchy presented, unless specifically stated otherwise. Furthermore, although an element may be described or claimed in a singular form, the plural can also be expected unless the limitation to the singular is explicitly stated. Thus, the present disclosure is not limited to the examples shown, and any apparatus for performing the functions described herein is included in the aspects of the present disclosure.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wires communication system, the method comprising:
identifying a resource subset corresponding to a transmission beam;
identifying one or more resources from the resource subset; and
transmitting at least one of a physical sidelink shared channel (PSSCH) or physical sidelink control channel (PSCCH) in a direction of the transmission beam.

2. The method of claim 1, wherein identifying the resource subset corresponding to the transmission beam comprises:
identifying at least one of candidate time units from a resource selection window for the transmission beam or candidate resources in the candidate time units;
excluding a resource from the candidate resources; and
identifying the resource subset based on the resource excluded from the candidate resources.

3. The method of claim 1, wherein identifying the resource subset corresponding to the transmission beam comprises:
identifying at least one of some time units from a resource sensing window as sensing time units for the transmission beam;
excluding a resource from candidate resources; and
identifying, based on the sensing time units, the resource subset based on the resource excluded from the candidate resources.

4. The method of claim 1, wherein identifying the resource subset corresponding to the transmission beam comprises:
identifying time units sensed based on a second reception beam as unsensed time units;
excluding a resource from candidate resources; and
identifying, based on the unsensed time unit, the resource subset based on the resource excluded from the candidate resources, wherein a direction of the second reception beam is different from a direction of the transmission beam.

5. The method of claim 1, wherein identifying the resource subset corresponding to the transmission beam comprises:
identifying a reference signal received power (RSRP) threshold value based on a reception beam of sidelink control information (SCI) received at a sensing time unit;
excluding a resource from candidate resources; and
identifying, based on the RSRP threshold value, the resource subset.

6. The method of claim 1, wherein identifying the resource subset corresponding to the transmission beam comprises at least one of:
identifying a resource subset corresponding to the transmission beam, the transmission beam being provided by a higher layer;
separately identifying a resource subset corresponding to each transmission beam in a set of transmission beams, the set of transmission beams being provided by the higher layer; or
separately identifying a resource subset corresponding to each transmission beam.

7. The method of claim 1, further comprising:
identifying time units from a resource sensing window as sensing time units for the transmission beam;
mapping each reception beam in a set of reception beams to a time unit or a set of consecutive time units sequentially and periodically; and
selecting the time units corresponding to a first reception beam from the resource sensing window as the sensing time units.

8. The method of claim 7, further comprising:
performing a sensing operation based on the first reception beam on the selected sensing time unit.

9. The method of claim 7, wherein, when each reception beam in the set of reception beams is mapped to the time unit or the set of consecutive time units sequentially and periodically, the time unit mapped to the reception beam is identified as a sidelink time unit.

10. The method of claim 7, wherein a number of the sensing time units selected from the resource sensing window for the reception beam is greater than or equal to a preset number of the sensing time units.

11. A user equipment (UE) in a wires communication system, the UE comprising:
a transceiver; and
a controller coupled with the transceiver and configured to:
identify a resource subset corresponding to a transmission beam,
identify one or more resources from the resource subset, and
transmit at least one of a physical sidelink shared channel (PSSCH) or physical sidelink control channel (PSCCH) in a direction of the transmission beam.

12. The UE of claim 11, wherein the controller is further configured to:
identify at least one of candidate time units from a resource selection window for the transmission beam, or candidate resources in the candidate time units;
exclude a resource from the candidate resources; and
identify the resource subset based on the resource excluded from the candidate resources.

13. The UE of claim 11, wherein the controller is further configured to:
identify at least one of some time units from a resource sensing window as sensing time units for the transmission beam;
exclude a resource from candidate resources; and
identify, based on the sensing time units, the resource subset based on the resource excluded from candidate resources.

14. The UE of claim 11, wherein the controller is further configured to:
identify time units sensed based on a second reception beam as unsensed time units;
exclude a resource from candidate resources; and
identify, based on the unsensed time unit, the resource subset based on the resource excluded from candidate resources, wherein a direction of the second reception beam is different from a direction of the transmission beam.

15. The UE of claim 11, wherein the controller is further configured to:
identify a reference signal received power (RSRP) threshold value based on a reception beam of sidelink control information (SCI) received at a sensing time unit;
exclude a resource from candidate resources; and
identify, based on the RSRP threshold value, the resource subset.

16. The UE of claim 11, wherein the controller is further configured to perform at least one of:
identifying a resource subset corresponding to the transmission beam, the transmission beam being provided by a higher layer,
separately identifying a resource subset corresponding to each transmission beam in a set of transmission beams, the set of transmission beams being provided by the higher layer; or
separately identifying a resource subset corresponding to each transmission beam.

17. The UE of claim 11, wherein the controller is further configured to:
identify time units from a resource sensing window as sensing time units for the transmission beam;
map each reception beam in a set of reception beams to a time unit or a set of consecutive time units sequentially and periodically; and
select the time units corresponding to a first reception beam from the resource sensing window as the sensing time units.

18. The UE of claim 17, wherein the controller is further configured to:
perform a sensing operation based on the first reception beam on the selected sensing time unit.

19. The UE of claim 17, wherein, when each reception beam in the set of reception beams is mapped to the time unit or the set of consecutive time units sequentially and periodically, the time unit mapped to the reception beam is identified as a sidelink time unit.

20. The UE of claim 17, wherein a number of the sensing time units selected from the resource sensing window for the reception beam is greater than or equal to a preset number of the sensing time units.
